(19) United States
(12) Patent Application Publication
(10) Pub. No.: US 2004/0167850 A1
(43) Pub. Date: Aug. 26, 2004

(54) Method of refinancing a mortgage loan and a closing package for same

(75) Inventors: Geoffery H. Dreyer, West Des Moines, IA (US); Mark C. Oman, West Des Moines, IA (US); Robert James Caruso, Charlotte, NC (US); Steven Arthur Bulmer, Apple Valley, MN (US); Eric A. Malchodi, Apple Valley, MN (US); Michael John DeVito, Urbandale, IA (US); Nancy G. Brennan, New York, NY (US); Michael J. Heid, Urbandale, IA (US); Timothy P. O'Brien, Charlotte, NC (US)

Correspondence Address: Brian J. Laurenzo, Dorsey & Whitney LLP, Suite 3900, 801 Grand Avenue, Des Moines, IA, 50309, US

(73) Assignee: Wells Fargo Home Mortgage, Inc., Des Moines, IA

(21) Appl. No.: 10/788,919

(22) Filed: Feb. 27, 2004

Related U.S. Application Data
(63) Continuation of application No. 10/259,116, filed on Sep. 27, 2002.

(51) Int. Cl. G06F 17/60

(52) U.S. Cl. 705/38

(57) ABSTRACT

A method of refinancing a mortgage loan is provided. The method of refinancing a mortgage loan comprises pre-approving a customer for refinancing of a mortgage loan. This customer is sent a pre-screened offer. The offer comprises materials setting forth the terms of the refinanced mortgage loan, materials providing all required pre-acceptance disclosures, and instructions describing how the customer may accept the offer. Upon receiving an indication of acceptance of the offer from the customer, a closing package is sent to the customer to be executed by the customer. The execution of the closing package by the customer creates a refinancing loan agreement. Also provided is a closing package for a mortgage loan comprising closing documents and a format and instructions providing specific guidance to the customer for completion and execution of the closing documents.

### CROSS REFERENCE TO RELATED APPLICATIONS

This application is a continuation of U.S. application serial No. 10/259,116, filed Sep. 27, 2002, entitled METHOD OF REFINANCING A MORTGAGE LOAN AND A CLOSING PACKAGE FOR SAME, which is hereby incorporated by reference.

### BACKGROUND OF THE INVENTION

The invention relates to the field of mortgage lending. In particular, the present invention provides a novel method of soliciting, originating, processing, closing and funding a mortgage loan.

Most individuals are not able to purchase real property outright. Therefore, traditionally, these individuals contact an institution that provides mortgage lending services. Similarly, individuals who wish to refinance an existing mortgage loan must contact an institution that provides refinancing services. These lenders provide funds to qualified individual customers to purchase or refinance real property using that property as security for the loan.

Refinancing is typically used when a customer has an existing mortgage loan on a property, but the customer wants to improve his or her circumstances. For example, the customer may use refinancing to obtain a lower interest rate on a loan, or to switch from an adjustable rate mortgage to a fixed rate mortgage. It is to be understood that the terms refinancing, refinancing a mortgage loan, refinancing a loan, and refinancing a home can be used interchangeably, and will be used herein, to define the process of refinancing real property using that property as security for the loan.

Methods of originating and processing a mortgage loan, and particularly refinancing a mortgage loan, involve a lender's assessment of the risk associated with providing a loan. Particularly, this assessment includes an evaluation of the customer's financial status, ability to repay the loan, and the value of the collateral used to secure the loan. The process also includes the steps taken by the lender to provide the funds to support a mortgage loan, such as; establishing a price for a particular mortgage loan, transferring funds to support this price, and hedging any potential interest rate risk to the lender in the market based on the mortgage offered. For example, a potential risk exists for interest rate fluctuation during traditional refinancing when a lender permits a customer to lock the interest rate at a set rate for sixty or ninety days on the potential mortgage loan. During this sixty or ninety day period, market interest rates may change, increasing or decreasing the value of the mortgage loan to the lender as a result of the locked interest rate. The risk of financial loss associated with this interest rate lock is hedged by the lender.

Obtaining refinancing for a mortgage loan typically proceeds similar to the process of obtaining a first mortgage loan. Traditional methods often involve a lender dealing specifically with an individual customer on an individual basis, in which each individual mortgage loan goes through its own origination and processing.

The refinancing process typically begins when a customer applies for a mortgage loan. Usually, a customer approaches a lender to apply for refinancing. However, current methods also exist in which a lender provides a customer with a firm offer for a mortgage loan, such as through a solicitation by mail. The process often continues by the customer's participation in a loan application interview, although a loan application interview does not always occur during traditional refinancing processes. During the loan application interview, a customer meets with a loan officer. The loan officer collects information needed by the lender to approve the loan. The loan officer also explains the types of loans available, the interest rates and fees involved, and the qualification requirements. The loan officer further aids the customer in completing a mortgage loan application. As an alternative, the customer may start a loan application online or may complete a limited loan application online.

To complete a loan application, a customer must provide financial information and other personal information. Particularly, the customer provides information in a variety of areas, including, for example, the property to be refinanced, the customer's address and social security number, the customer's employment history, and the customer's financial history. Because a customer may be more than one person, this information may need to be provided for more than one person.

After the loan application interview, or after completion of the loan application, the lender typically registers and establishes the potential new loan on its loan origination system. The documents and other disclosures obtained from the application process are sent to a processing center for verification and evaluation. The lender evaluates the information provided to ensure that the correct information was provided to the lender, including the correct documents. This typically involves the lender contacting references, confirming information listed in the application, and obtaining a tri-bureau report, or credit report, and a credit score for the customer from a credit bureau. Specifically, loan application verification is performed by a loan processing department and an underwriter. The responsibility of a loan processor is typically to send out the verifications of employment and deposit, order the tri-bureau report and credit score from the credit bureau, order the property appraisal, and obtain any other documents associated with a particular application to refinance a mortgage loan, such as title insurance, a title commitment, a title opinion and flood determinations. These orders are generally either electronically or verbally submitted by the processing department to the appropriate vendor. Ultimately, the time it takes to receive the documents and verify the information affects the overall length of time required for the lender to approve the application.

Once the necessary documents are collected, they are sent to an underwriter. The underwriter ultimately makes the decision to approve or reject the loan. The underwriter verifies the information in the application, and evaluates whether the customer is eligible to receive refinancing for a mortgage loan. Additionally, a determination is made regarding the amount of money that the lender is willing to provide. Specifically, the information investigated by the underwriter includes the customer's personal information and finances, such as: bank account information, current loan amounts and payments, and credit cards; an appraisal of the property; the year the property was acquired; the original cost of the home; the cost and a description of any improvements; the amount of any liens; a complete mailing address for the property, the property's age and its full legal description; the customer's social security number, age, schooling, marital status, dependents, current address, length of time at a current address, current housing expenses; and employment history, including sources of income. Personal assets and personal indebtedness are also reviewed.

One additional step in a lender's decision to provide refinancing to a customer is an evaluation of the property itself The lender evaluates the appraised value of the property to be refinanced in addition to legal title considerations. In several states, title considerations are evaluated by a title vendor who provides title search and insurance services. The title vendor checks for encumbrances on the property and insures the property against any prior claim of ownership made by another. In states that do not permit use of a title vendor, an abstractor typically performs the necessary title search and an attorney issues a title opinion based on the title search. The information obtained is evaluated to determine whether the lender will provide a mortgage loan or refinancing to that customer for that property.

Within three business days after the customer's completion of the application for a mortgage or for refinancing, the lender is required by law to provide a Good Faith Estimate of the anticipated closing costs to the customer. The Good Faith Estimate demonstrates to the customer the costs associated with a loan settlement, such as origination fees, mortgage insurance, title insurance, escrow reserves, and hazard insurance. Also within this time frame, the customer must receive an initial Truth-In-Lending disclosure statement. The Truth-In-Lending statement discloses to the customer the estimated monthly payment and total cost of all finance charges on the loan, along with various state specific disclosures.

Generally, the information collected by the lender provides a background of the customer on which to base a decision whether to approve refinancing of a mortgage loan for that customer. As can be seen, a great deal of information must be collected and reviewed for each individual customer, as well as provided to the customer. In fact, multiple parties must work together to provide enough information to the underwriter for the underwriter to determine whether to approve a customer for the refinancing of a mortgage loan.

Due to the numerous steps involved and items to review, the mortgage origination and approval process for traditional refinancing processes takes several days, if not several weeks, to complete. Considering that numerous documents must be provided to the lender from both the customer and the vendors, the processing of the application to refinance is very paper-intensive, and therefore, very time consuming. The entire process, from application for refinancing of a mortgage loan to closing of the loan, can in some cases take up to five weeks to complete, depending on the type of mortgage involved and the complexity of the customer's circumstances. As a result, risks and costs are added to the process for both the customer and the lender. Furthermore, there is no guarantee that an individual customer will be approved for refinancing of a mortgage loan.

Significant time, expense, and effort are also incurred by the lender. The lender must rely on the customer for information. The lender must also evaluate each individual customer on an individual basis, making various requests for information from vendors for each customer.

If the lender approves the customer for refinancing, a closing date is set and the customer typically receives a commitment letter. The commitment letter sets out the terms of the loan and the length of time those terms are offered. Commitment letters also often include fees, tax information, insurance information, and closing requirements. Occasionally, the commitment letter will have conditions, such as requiring proof of hazard insurance, before a mortgage loan will be provided by the lender. The customer accepts this commitment by returning a signed copy of the commitment letter to the lender, typically within five to ten business days. The signed commitment letter assures the customer that the mortgage lender will provide the loan subject to the listed conditions being met.

Once the customer is approved for refinancing of a loan and has signed the commitment letter, the method of refinancing a mortgage loan proceeds to the stage of closing the mortgage loan. At the closing the final documents are signed and the arrangements for possession are completed. The lender also often provides any necessary disclosures to the customer and helps the customer complete the closing documents. A brief list of some of the closing documents involved in a typical closing are: a rider; a settlement statement, called a “HUD”; a deed of trust; a right to cancel; a note; a mortgage; and a legal description of the property. The numerous and lengthy closing documents must be obtained and assembled by the lender prior to the closing. The different closing documents are typically placed together in a file. Each individual closing document is then presented to the customer for review and execution during the closing. Considering the closing documents are not usually bound together, there is a risk that one or more of the documents may be lost or misplaced during the process of executing the documents, as well as during processing by the lender. Likewise, there is a risk that the lender may not obtain all of the documents that must be signed, or will obtain the wrong documents. Furthermore, lenders do not typically mark each individual closing document for purposes of tracking the document in the lender's mortgage loan systems or for processing of the document. Instead, the lender typically relies on the customer name listed on the closing document. The lack of any effective tracking system for each closing document increases the risk that a closing document might be lost during the execution and processing of the closing documents.

Traditionally, the closing takes place by a meeting between at least the customer and the loan officer, an attorney, or a closing agent, at the loan officer's business office, at the escrow agent's office, or at the attorney's office. This varies by state regulation and practice. The documents involved in closing are quite lengthy, complex, and confusing, often taking a significant amount of time to read, understand, execute, and have notarized. In fact, often the closing documents contain more disclosures and request the customer to execute more documents than are actually required by law or practice, wasting the time of both the customer and the lender. The closing itself takes an hour or more to complete. Additionally, because the closing requires a meeting, it adds additional time, hassle, and expense for the customer and the lender. Thus, the traditional closing process, including lengthy, complex documents and a meeting, adds significant time, expense, and effort to the process of refinancing a mortgage loan for both the customer and the lender.

Subsequent to, or at the end of the closing, settlement of the loan occurs. During settlement, the necessary funds are exchanged, including any down payment, costs, or fees associated with the mortgage loan. Closing costs typically include an origination fee, discount points, interim interest, and any third party fees, such as an appraisal fee, a mortgage recording fee, processing/underwriting fees, title insurance fees, an escrow officer's fee, homeowner's insurance fees, miscellaneous courier and transaction fees, escrow account funds, private mortgage insurance fees, and a credit report fee. For first mortgages and occasionally refinancing, settlement may also typically involve the payment of any third parties that are owed money from the proceeds of the transaction. During settlement, the lender verifies that the appropriate documents have been signed and notarized. The mortgage loan is then funded by the lender. The mortgage is subsequently distributed for recording in the appropriate county recording offices. A copy of the mortgage is also sent to the customer. Often, settlement further includes paying off a prior mortgage loan and a release of a prior lien on a property. Additionally, during a traditional method of obtaining a first mortgage loan, and occasionally refinancing, welcome letters are sent to mortgage customers by their servicers shortly after the loan is closed.

The refinancing process then proceeds to post-closing. During post-closing, the mortgage loan file generated for the customer is combined with materials from settlement. The materials and documents are verified and checked for completeness. The verification process involves comparing the customer loan file with a checklist to determine whether any deficiencies exist. If deficiencies are discovered, they must be resolved by the lender. The lender then determines whether to retain or to sell each mortgage loan. In some cases, for loans that are sold by the lender, the lender provides the original mortgage documents to a custodian. However, these original mortgage documents are often retained by the lender. The loans are reviewed by the lender to determine if the loan is saleable. A saleable mortgage may subsequently be pooled with other saleable mortgages obtained by the lender and sold to a third party on the secondary market. However, a lender may retain some or all of these mortgages in its portfolio. Similarly, the lender may choose to sell or retain the servicing associated with some or all mortgage loans.

In an effort to reduce the lengthy approval process, lenders have provided alternative processes for customers in an attempt to increase the rate of approval for obtaining or refinancing a mortgage loan. In each of these situations the customer is typically in the process of evaluating whether to obtain a mortgage loan, or to refinance, and evaluating which lender to approach for such a loan.

While typically associated with obtaining first mortgages, one alternative provided by lenders is a pre-qualification process. For first mortgages, pre-qualification provides a customer with a comfort range regarding the amount of money a lender is willing to provide the customer for a mortgage loan. The lender is also provided certain information about the customer and has taken steps to preliminarily qualify the customer for a mortgage loan at an early stage of the process. Therefore, fewer steps and less information is needed at the time the customer decides to proceed in obtaining a mortgage loan.

A customer applies for pre-qualification by completing an application or by giving authorization to obtain a credit report. This application provides the lender particular financial information about the customer, such as household income, total indebtedness, employment history, and funds available for closing. The customer's credit history is also obtained. The lender then decides whether a customer is preliminarily qualified for a mortgage loan and how much money a customer is qualified to receive. This decision is communicated to the customer. Therefore, at the time the pre-qualified customer decides to proceed with obtaining a mortgage loan, the customer may have already completed the preliminary stages of the application process. The pre-qualified customer also has a general understanding of whether the particular property of interest falls within the range of the loan amount that the customer is qualified to receive. Similarly, the lender has already completed some of the preliminary steps of the approval process for the pre-qualified customer. Therefore, less work needs to be performed by the lender at the time the customer decides to complete the process of obtaining a mortgage loan. After the customer notifies the lender of the customer's decision to obtain a mortgage loan, the remaining steps for completion of mortgage loan origination and processing continue by following the same process as other traditional processes.

While pre-qualification provides a little more information to the lender at the preliminary stages of applying for a mortgage loan, it has not improved the overall timeframe in which to complete the process of obtaining a mortgage loan, nor has pre-qualification reduced the effort required of the customer or the lender. The steps of the process are simply spread out, as opposed to processes that involve a continuous flow from one step to the next. In other words, the customer and the lender begin the application process, wait a period of time for the customer to make a decision, then complete the process after the customer notifies the lender of its decision. The customer is still required to approach a lender to request a mortgage loan, which includes gathering various types and amounts of financial and personal information. The customer is also required to complete a mortgage loan application, await a lengthy approval period, and participate in a lengthy closing process. Moreover, there is no guarantee the customer will obtain a loan for the particular property. Likewise, the lender is still required to evaluate each customer individually, and to maintain mortgage loans and the processing thereof on an individual basis. Thus, the time, effort, and expense to the customer and the lender have not been reduced by pre-qualification.

“Pre-approval” is another alternative provided by lenders in an attempt to avoid the prior problems of the lengthy timeframe in which to complete the overall process of refinancing a mortgage loan, the extensive effort required of both the customer and the lender, and the paper-intensive nature of these processes. A customer either approaches a lender and applies for refinancing, or alternatively, a lender solicits a customer, encouraging the customer to approach the lender for refinancing. During a pre-approval process, the customer typically completes a pre-approval application. This application collects necessary financial and personal disclosures. The lender also obtains a credit report and credit score for the customer. The lender then submits the information obtained to a processing department and to an underwriter for approval. The information obtained is evaluated by the lender who then either approves or denies that customer for refinancing of a mortgage loan. Approval for a loan, however, is usually contingent upon a satisfactory property appraisal and a satisfactory title review of the property. Therefore, after the customer makes the decision to complete the process of obtaining a mortgage loan or refinancing, the lender is typically contacted and provided the information necessary to complete an appraisal and a title review for that property. A final decision is then made by the lender whether to approve the customer and property for a mortgage loan or refinancing. Similar to pre-qualification, after approval of the customer and the property, the process continues in the same manner as other traditional processes.

A pre-approval process, like pre-qualification and other traditional processes, takes a significant amount of time. No steps have been eliminated from the process for the customer or the lender. Instead, the steps are merely spread out. The customer must still approach the lender to complete an application. The customer must also provide a significant amount of information to the lender to complete the process. The customer also participates in a lengthy closing process. The lender, likewise, must participate in and complete the lengthy application, approval, closing and processing of the customer's request for a mortgage loan or refinancing. Furthermore, there is no guarantee the applicant will be provided a mortgage loan or refinancing. Therefore, significant time, expense, and effort are required of both the customer and the lender with little assurance that the customer will in fact successfully obtain a mortgage loan or refinancing.

Currently, origination and processing methods also exist for refinancing, different from pre-approval and pre-qualification processes, that provide accelerated approval of a customer for a mortgage loan, faster processing, and reduced costs for the customer. Such methods typically have reduced documentation requirements that contribute to the accelerated process. Specifically, the lender may not obtain income and asset verification for the customer. Additionally, a credit review of the customer and an appraisal of the property may not be requested by the lender in those markets that permit such reductions. However, often with such accelerated processes, information must still be provided by the customer and subsequently processed by the lender. Therefore, while saving some time for the customer and the lender, a large amount of time, effort, and expense is still required of the customer and the lender to evaluate the customer's eligibility for refinancing.

In one alternative of this accelerated process, the lender pre-screens customers with information it obtains on its own, and provides these pre-screened customers a firm offer to refinance a mortgage loan. As a result of the pre-screening, the lender needs less information from the customer to approve the customer for refinancing after the offer is sent to the customer. Customers are pre-screened by comparing these customers to a set of criteria to determine whether these customers qualify for refinancing. As examples, such criteria may include: whether the customer has accepted an offer from a previous campaign offered by the lender; a credit score above a certain value; whether the customer has been delinquent in payment of a mortgage loan; whether the customer has filed for bankruptcy; the type of property involved; whether a disaster has occurred on the property; whether the customer's loan has been foreclosed; whether the customer has a foreign address; whether the customer's existing loan is in collections; loss mitigation; or whether the customer was part of the armed forces. Those customers that are pre-screened and found to satisfy all criteria used to select the eligible customers are typically sent an offer to refinance from the lender.

In this situation, a broad group of people are often solicited with an offer to refinance. The offer presented to the customer provides the customer information indicating that the customer is qualified to receive “up to” a dollar amount for a refinanced mortgage loan and asks the customer to contact the lender to learn more about this offer. No specific interest rate or price adjustments are applied to the offer to refinance at this time. Therefore, upon receipt of the offer, the customer must approach the lender and provide further information to the lender to determine the specific amount of money the lender is willing to provide and the terms of such a refinanced mortgage loan. Furthermore, these offers, while reduced in cost, often still include some of the costs associated with refinancing of a mortgage loan. Therefore, the effort and expense for the customer and the lender have been reduced, but not eliminated. The customer must still provide information to the lender for processing. Additionally, the lender must still process the customer's additional information and participate in a traditional closing. Therefore, the overall process of refinancing a mortgage loan, even for an accelerated approval process, is still a lengthy, time consuming process. Moreover, the customer is not provided a specific loan amount in the offer. The customer is only provided an amount “up to” a certain level. Therefore, the customer must complete the approval process before being able to determine for certain whether and how much money the lender is willing to provide.

While pre-qualification, pre-approval, and accelerated approval methods allow the customer and the lender to complete some of the preliminary mortgage origination steps earlier than other traditional processes, thus far, it has been difficult for lenders to provide a pre-approval process that is not initiated by the customer due to the laws, regulations, and steps involved in the overall process of refinancing a mortgage loan.

In view of the foregoing, therefore, a need exists for a method of refinancing a mortgage loan that has shorter time frames for the customer, and results in a closing package that can be closed at the customer's convenience. A need also exists for a method of refinancing a mortgage loan that provides the customer immediate knowledge of the terms and amount of the mortgage loan, and reduces the effort and expense required of the customer and the lender. A further need exists for a method of refinancing a mortgage loan in which a lender is able to pre-approve customers in bulk, send the same offer to multiple customers, perform various preparation and processing steps in bulk, and send closing packages in bulk, reducing the lenders overall time and costs.

The difficulties encountered in the prior art are substantially eliminated by the present invention.

### SUMMARY OF THE INVENTION

By the present invention, it is proposed to overcome the difficulties encountered heretofore. To this end, a method of refinancing a mortgage loan and a closing package for same is provided. The method of refinancing a mortgage loan comprises pre-approving a customer for refinancing of a mortgage loan. This customer is sent a pre-screened offer for refinancing a mortgage loan. The offer comprises materials setting forth the terms of the refinanced mortgage loan, materials providing all required pre-acceptance disclosures, and instructions describing how the customer may accept the offer. Upon receiving an indication of acceptance of the offer from the customer, a closing package is sent to the customer to be executed by the customer. The execution of the closing package by the customer creates a refinancing loan agreement. This closing package comprises closing documents and a format, and instructions providing specific guidance to the customer for completion and execution of the closing documents.

The primary objective of the method of refinancing a mortgage loan of the present invention is to provide a method of refinancing a mortgage loan that has shorter time frames for the customer and the lender, and results in a closing package that can be closed at the customer's convenience.

These and other objects will become apparent upon reference to the following specification, drawings, and claims.

### BRIEF DESCRIPTION OF THE DRAWINGS

FIG. 1 shows a flow chart of the method of refinancing a mortgage loan of the present invention showing offer creation and pre-approval.

FIG. 2 shows a continuing flow chart from FIG. 1 of the method of refinancing a mortgage loan of the present invention showing the steps of order entry.

FIG. 3 shows a continuing flow chart from FIG. 2 of the method of refinancing a mortgage loan of the present invention showing the steps of fulfillment.

FIG. 4 shows a continuing flow chart from FIG. 3 of the method of refinancing a mortgage loan of the present invention showing the processing of closing packages.

FIG. 5 shows a continuing flow chart from FIG. 4 of the method of refinancing a mortgage loan of the present invention showing the settlement of the mortgage loan and payoff.

FIG. 6 shows a continuing flow chart from FIG. 5 of the method of refinancing a mortgage loan of the present invention showing the settlement of the mortgage loan and funding.

FIGS. 7a & 7b show a continuing flow charts from FIG. 6 of the method of refinancing a mortgage loan of the present invention showing the pooling and sale of mortgage loans.

FIG. 8a shows a flow chart of the method of refinancing a mortgage loan of the present invention in which an offer is sent to a customer.

FIG. 8b shows a flow chart of the method of refinancing a mortgage loan of the present invention in which a customer approaches a lender to request refinancing.

FIG. 9 shows a perspective view of a closing package workbook of the present invention.

FIG. 10 shows a perspective view of a closing package workbook open to show an attached document.

FIGS. 11a & 11b show a set of instructions and document listing of the closing package for the documents to be incorporated into the closing package of the present invention.

FIG. 12 shows a checklist of instructions for completing the closing package which is incorporated into the closing package of the present invention.

FIG. 13 shows instructions to a notary which are incorporated into the closing package of the present invention.

FIG. 14a through FIG. 14d show instructions for completing a note and a note document which are incorporated into the closing package of the present invention.

FIG. 15a through FIG. 15p show instructions for completing a mortgage or deed of trust and a mortgage document which are incorporated into the closing package of the present invention.

FIG. 16a through FIG. 16f show instructions for completing a document containing business acknowledgements, agreements and disclosures, and the business acknowledgements, agreements, and disclosures document which are incorporated into the closing package of the present invention.

FIG. 17a through FIG. 17e show instructions for completing the acknowledgment of receipt and notice of the right to cancel, and the acknowledgement of receipt and notice of the right to cancel documents which are incorporated into the closing package of the present invention.

FIG. 18a through FIG. 18d show instructions for completing the borrower's title affidavit and the borrower's title affidavit which are incorporated into the closing package of the present invention.

FIG. 19 shows a list of frequently asked questions document that is incorporated into the closing package of the present invention.

FIG. 20 shows a Good Faith Estimate which is incorporated into the closing package of the present invention.

FIG. 21 shows an Affiliated Business Arrangement Disclosure which is incorporated into the closing package of the present invention.

FIG. 22 shows a Servicing Disclosure Statement which is incorporated into the closing package of the present invention.

FIGS. 23a & 23b show a Uniform Settlement Statement which is incorporated into the closing package of the present invention.

FIG. 24 shows a Truth-in-Lending Disclosure which is incorporated into the closing package of the present invention.

### DETAILED DESCRIPTION OF PREFERRED EMBODIMENTS

The Figures show a method of refinancing a mortgage loan and a closing package for same. The method of refinancing a mortgage loan comprises pre-approving a customer for refinancing of a mortgage loan. This customer is sent a pre-screened offer for refinancing a mortgage loan. The offer comprises materials setting forth the terms of the refinanced mortgage loan, materials providing all required pre-acceptance disclosures, and instructions describing how the customer may accept the offer. Upon receiving an indication of acceptance of the offer from the customer, a closing package is sent to the customer to be executed by the customer. The execution of the closing package by the customer creates a refinancing loan agreement. This closing package comprises closing documents and a format, and instructions providing specific guidance to the customer for completion and execution of the closing documents.

It is contemplated that the method of refinancing a mortgage loan of the present invention can be used to create various mortgage loans, including, but not limited to, residential mortgage loans, FHA loans, borrower paid mortgage insurance loans, lender paid mortgage insurance loans, jumbo mortgage loans, fixed rate mortgages, adjustable rate mortgages, and mortgages for a term of years.

As will be described in detail in the following description, the method of refinancing a mortgage loan of the present invention is streamlined in comparison to traditional methods of refinancing a mortgage loan. Particularly, the present invention reduces the number of steps required for the customer to complete the refinancing process. One feature of the present invention that streamlines the method of refinancing involves a lender sending an offer to refinance a mortgage loan to a pre-approved customer that contains materials setting forth the terms of the refinanced mortgage loan, materials providing all the required pre-acceptance disclosures, and instructions describing how the customer may accept the offer, eliminating the customer's need to complete the application process.

The closing package of the present invention also streamlines the process of refinancing a mortgage loan. Specifically, the closing package has fewer documents to be reviewed and executed by the customer as compared to traditional refinancing processes. Furthermore, the closing package of the preferred embodiment contains detailed instructions associated with a checklist for the customer to follow, permitting quick and easy execution of the closing package documents. Aside from the reduced documentation and instructions of the closing package, the customer is also not required to provide any additional documentation at the time of closing. Moreover, the closing packages are sent to the customer to be completed and executed, and may be completed by the customer at the customer's convenience within a specified time period.

Furthermore, each of the customer's acceptance steps can be completed by telephone or electronically, including through the Internet. Therefore, a meeting between the loan officer, an attorney, or a closing agent and the customer is not necessary, with the exception of those states in which a meeting is required by law. The steps of the method of refinancing a mortgage loan of the present invention are reduced for the customer. Specifically, the customer's steps include accepting an offer to refinance that is sent to the customer, and completing a closing package connected with this offer. Accordingly, the time, effort, and expense required of both the lender and the customer are greatly reduced from current methods of refinancing a mortgage loan.

Ultimately, the streamlined pre-approval and closing processes of the present invention significantly reduce the amount of work for the customer, by not requiring the customer to fill out an application, attend a loan application interview, or provide a significant amount of background information to the lender. The lender has already completed, or has figured electronic solutions, or has eliminated these steps prior to the customer's receipt of the offer. It is contemplated, however, that some of these steps may be included in the process without departing from the overall scope or streamlined nature of the invention. Moreover, the lender sends these pre-approved customers an offer in which the specific terms of a potential new mortgage loan are provided, disclosing to the customer the precise details of the mortgage loan that the customer is eligible to receive and simplifying what is required of the customer to obtain this loan. The customer only needs to accept the offer.

The lender is also benefited. Specifically, the lender is able to pre-approve customers in bulk, send the same offer to multiple customers, perform various preparation and processing steps in bulk, and send closing packages in bulk, reducing the lenders overall time and costs, whereas current methods of refinancing a mortgage loan are performed on an individual by individual basis. Furthermore, the lender does not need to rely on the customer for information to complete an application, and, with some exceptions, does not meet with the customer to close the loan. Therefore, the lender's overall time, effort, and expense in working with the customer to provide a refinanced mortgage loan is significantly reduced.

Preliminarily, in the preferred embodiment, a lender designs an individual campaign that it wishes to offer its customers based on the particular goals of the lender. The lender decides, as one example, that it is willing to offer its customers a reduced mortgage rate in exchange for a customer's refinancing of a mortgage loan. It is noted that any purpose for offering refinancing would be acceptable for purposes of the present invention. The lender prepares offers to customers to meet the goals of its individual campaign. The lender uses these goals to establish a list of customers that it wishes to include in the campaign.

Accordingly, as will be described in detail herein, the preferred method of refinancing a mortgage loan begins with a lender creating a set of criteria from which it will select a customer from a group of customers who have existing mortgage loans. Secondly, the selected customer is pre-approved for refinancing of a mortgage loan. An offer to refinance a mortgage loan is then prepared for the pre-approved customer. This offer has definite requirements, obligations, and disclosures associated with the mortgage loan. Particularly, the pre-screened offer comprises materials setting forth the terms of the refinanced mortgage loan, materials providing all required pre-acceptance disclosures, and instructions describing how the customer may accept the offer. It is further contemplated that additional information or material may be added to this offer or removed from the offer without departing from the overall scope of the invention. After the offer is prepared, it is provided to the pre-approved customer. The lender then provides a limited period of time in which the customer may accept the offer.

While the lender may provide an offer to a customer by sending the offer to the customer, it is also contemplated that a pre-approved customer or pre-qualified customer may approach the lender to request refinancing of a mortgage loan. Following the customer's request, an offer is communicated by the lender to the customer for a mortgage loan. In this situation, as opposed to being sent to the customer, the offer is verbally communicated to the customer. However, the offer may be communicated by any means that would convey an offer to a customer, including without limitation, a written or electronic formatted offer. If the customer accepts the offer, the customer is provided a closing package to be executed by the customer. Upon execution of the closing package, a refinancing loan agreement is created.

Alternatively, the lender may prepare an offer to refinance a mortgage loan for a group of customers. Accordingly, a set of criteria is first created from which a list of customers to be provided the offer is created. Customers to be provided an offer may be selected from a group of customers who have existing mortgage loans. In the preferred embodiment these customers are obtained from master customer lists. Those customers who are qualified to receive an offer to refinance a mortgage loan based on a particular campaign are considered pre-approved, placed on the target list, and provided an offer to refinance a mortgage loan.

The method of refinancing a mortgage loan of the preferred embodiment continues when the lender receives a communication from a customer who has received this offer, either accepting or declining the offer within the appropriate time period. When the customer accepts the offer, a closing package is prepared and sent to the customer. Alternatively, it is contemplated that the steps of providing an offer to the customer and providing closing documents to the customer could be combined into a single step.

Once the customer receives the closing package, the customer completes and executes the documents and disclosures contained therein. Subsequently, the customer returns the completed closing package to the lender. The lender then processes the completed documents contained within the closing package.

After the documents in the completed closing package are processed and determined to be acceptable, the lender funds a new loan based on the information gained from the processing of the completed closing package. The lender then settles the existing mortgage loan by paying off the existing mortgage loan for the customer. Subsequently, the customer's mortgage loan is pooled with mortgage loans from other customers of the lender and sold on the secondary market. It is contemplated, however, that the lender may retain some, or all, of these loans in its portfolio. Additionally, the lender may sell the servicing associated with some, or all, of these mortgage loans, or alternatively the lender may retain the servicing of the loan, or loans, for itself.

A preferred embodiment of the method of refinancing a mortgage loan of the present invention comprises computer control of at least a portion of the process. However, it is contemplated that the entire process may be controlled by a computer. Alternatively, it is contemplated that the process may be completed manually. Particularly, the computer is a programmable computer as is commonly used in the art, such as a personal computer or a networked computer. The computer is provided with and implements software with the specific functions described herein for the refinancing process. Furthermore, the computer also exchanges information with various databases and other stores of information. In the preferred embodiment, a computer operates a loan information system. The loan information system is software that is implemented on the programmable computer which manages, controls, and tracks the workflow of one or more mortgage loans during origination and processing. Loan information is obtained from customer databases and provided to the loan information system. The loan information system of the preferred embodiment is capable of facilitating high volume, short duration loan origination and print processes. This loan information system manages loan information for each individual mortgage loan, or multiple loans at one time in a batch. The loan information system serves to transfer loan information for individual loans, or multiple loans in a batch, throughout the lender's mortgage loan systems. The loan information system also tracks the status of an individual campaign associated with a particular offer as the information associated with this offer or campaign proceeds through the refinancing process systems. The loan information system is further capable of storing lengthy full legal descriptions associated with the properties involved in the refinancing campaign. The preferred embodiment of the loan information system also has reporting capabilities. Particularly, the preferred embodiment generates reports for review by the lender at different stages of the refinancing process. These reports include, but are not limited to, clearance reports, upload reports, funding reports, and executive summaries.

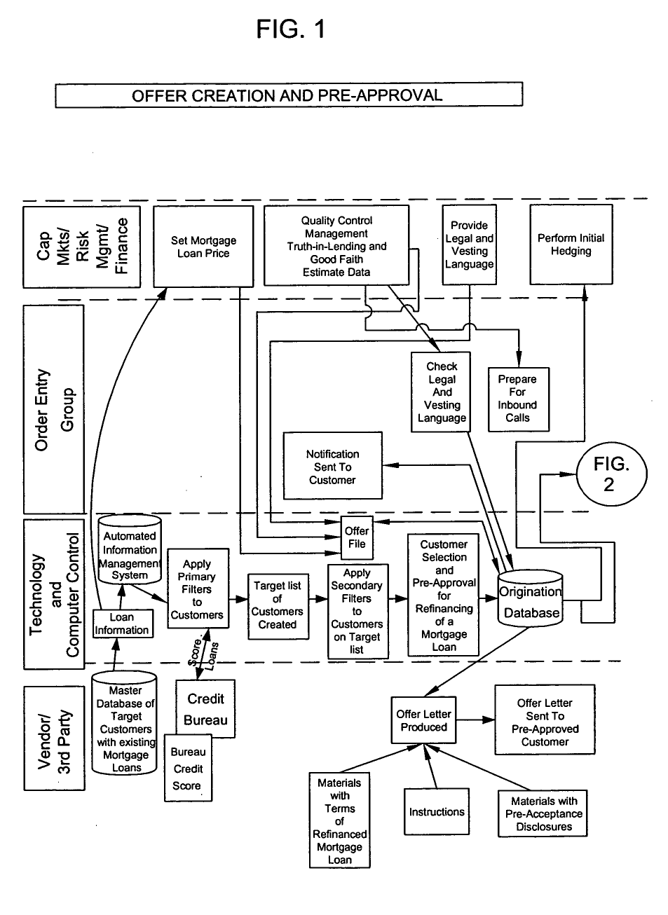

Referring to the figures, FIG. 1 presents the steps involved in preparing a pre-screened offer for a mortgage loan. In the preferred embodiment of the method of refinancing a mortgage loan, a lender prepares an offer for at least one customer, but preferably for multiple customers. First, a master database of target customers (“master database”) is created. For refinancing mortgage loans, this master database of target customers is created by the lender from the lender's own files, although it is contemplated that a third party's files or databases could be used for this purpose. Likewise, for other types of mortgages, master databases may be created from the lender's customer databases or from third parties. It is further contemplated that the information may be obtained from a global computer network or from written or printed records. In the preferred embodiment, a third party maintains customer data owned by the lender. Therefore, the third party must be contacted to obtain customer information from the lender's master database of target customers.

A first set of criteria is then compared to the lender's master database of target customers. A target group of customers that have existing mortgage loans is selected from the lender's master database based on the criteria applied. The target group of customers is prepared by querying the master database using an automated information management system. The automated information management system is software implemented on a programmable computer that controls and regulates the flow of information through the lender's systems, and includes search capabilities. The automated information management system obtains data from the lender's various internal sources and can be used to query specific factors. Furthermore, the automated information management system adds additional information to the customer list that was not previously obtained or not available from the master database, such as demographic information. Specifically, the automated information management system filters the master database of target customers using a set of primary criteria. Particularly, criteria is applied to the master database of target customers using a waterfall process, in which each criterion is applied individually and successively to the master database. Those customers who do not satisfy that particular criterion are removed from consideration for the particular campaign. Thus, a first criterion is applied and customers are excluded. A second criterion is applied and additional customers are excluded. Then a third criterion is applied and further customers are excluded, continuing with the application of criterion until the lender has applied all the primary criteria for a particular campaign. Those customers on the master database that meet each of these primary criteria are placed into a target group or list of customers. While a waterfall process is illustrated, it is understood that any method of filtering the list of customers would be acceptable for purposes of the present invention, so long as the resultant group of target customers satisfies the lender's criteria for a particular campaign.

The filters, or primary criteria, are established by the lender for a particular campaign or offer to determine which potential customers qualify to receive the offer. The customer's financial history, personal history, and other factors are compared to these filters to determine a customer's eligibility for a particular offer to refinance. Examples of filters, or primary criteria, include, but are not limited to: whether the customer has filed for bankruptcy; whether the customer has a current mortgage and the age of that particular mortgage; the number of years that the customer has existed in the lender's mortgage system; and whether the customer has been delinquent in any payments on a particular mortgage or other loan payments. The preferred embodiment of the present invention applies some criteria similar to those criteria used to pre-screen customers during accelerated approval methods. However, the preferred embodiment also, to the extent provided by law, applies additional criteria that allow the lender to provide an offer with specific terms to the customer. These additional criteria include, but are not limited to: a principal balance above a certain amount; the property type, such as a church, second home, or investment property; whether the current loan is a sub-prime loan; whether any prepayment penalties exist on the existing loan; when the next payment on the existing loan is due; the age of the loan, particularly whether the loan is too old or too young for the lender's purposes; whether the loan has an irregular term length; the type of loan, such as an ARM loan, balloon loan, or buydown loan; whether the existing loan is on a second home; whether the property is an investment property, a condominium, a town home, or a multi-family dwelling; whether the property is not occupied by the owner; the state in which the property exists; a monthly savings to the customer above a certain amount; whether an appraised value exists for the property and the amount of that appraised value; whether mortgage insurance exists for the property; a loan-to-value ratio above a certain amount; whether the new payment for the refinanced loan would require mortgage insurance; whether the asset value is within certain limits; and whether the customer has bad credit. Furthermore, contrary to accelerated processes that use pre-screening, the use of the monthly savings to the customer as a criterion additionally requires the lender to provide an interest rate and price adjustments for the particular loan to be offered to the customer to determine the monthly savings.

Most states have differing requirements for obtaining refinancing of a mortgage loan. For example, in different states different disclosure requirements exist, as well as different lending restrictions such as: regulations on high cost loans impacting a lender's ability to provide refinancing; state laws regulating cash out refinancing; limitations on refinancing loans that are less than twenty-four months old; differing provisions for title insurance; attorney review of documents; and face-to-face closings. The examples listed merely represent possible differences in state requirements and are not meant to be an exhaustive list. It is understood that the present invention contemplates variations in such state requirements. It is also contemplated that the offers to refinance, closing packages, and resulting mortgage loans of the present invention can be tailored to meet such differing requirements.

In the preferred embodiment, after preparing the target list of customers by filtering the master database of target customers with the first set of criteria, the interest rate to be applied to the resulting mortgage loan and the Truth-in-Lending data are calculated for the individual customer offers. This information is then appended to these offers.

Subsequently, at least one credit bureau is contacted and a credit score for each individual customer in the target group of customers is obtained to be used for further filtering of the target group. A credit score that must be above a certain limit is applied as a filter. In a preferred embodiment, credit scores from more than one credit bureau are combined to generate a single credit score for a particular customer to be used as a filter. Preferably, a tri-bureau credit report and credit score is obtained for each customer. In addition to contacting a credit bureau, a vendor is also contacted to obtain a flood certification for the property involved. An evaluation is also made of the most recent paid in full customer information, such as loans that have been paid off, and pipeline customer information, such as loan applications in process that have not yet closed. Furthermore, escrow account balances are evaluated for flood and insurance purposes. Each of these additional steps result in further information or criteria to be used in filtering the target group of customers.

Particularly, after the first set of exclusions based on the primary criteria occurs, the lender performs a further evaluation of the customer and loan information for each customer in the target group of customers for a particular campaign. The lender reviews and evaluates the information obtained regarding the customer, or to be provided to the customer, to ensure the information is valid and acceptable for the lender's purposes. In the preferred embodiment, an evaluation of the offers and associated information is performed by computer analysis of the criteria, information, and documents. A subsequent manual review is performed when deficiencies are noted by the computer. Specifically, the lender implements a software program on a programmable computer that compares a second set of criteria as filters to the target list of customers to further narrow the group of customers who are eligible to receive the offer. The second set of criteria includes, but is not limited to: credit scores above a certain level; flood determinations for the properties involved; whether there is a lack of any address listed for a particular mortgage loan record; any escrow criteria; and any other relevant determinations or data problems. The customers in the target group that do not satisfy these additional criteria are not provided an offer to refinance a mortgage loan. Accordingly, the customers in the target group that remain after applying the second set of criteria are provided an offer to refinance.

These same steps and filters are applied to each customer in the master database for a particular campaign, ultimately resulting in a reduced group of target customers who meet each criterion and are therefore eligible, or pre-approved, to receive the offer to refinance from the lender. It is contemplated that any criterion that would aid the lender in determining whether to provide a customer an offer would be acceptable for purposes of the present invention. Furthermore, the primary and secondary criteria, or any combination of criteria, could be applied in a single step to result in a target list of customers, or alternatively, no criteria could be applied to select customers. The result of filtering these customers with the specific criteria is that a list of customers who are pre-approved for refinancing of a mortgage loan is created for the lender. Therefore, the lender can pro-actively offer these customers a loan. Creating an offer from the lender's own criteria in this manner creates an internal confidence level for the lender, in addition to satisfying the concerns of the lender's investors.

As shown in FIG. 1, once the target group of pre-approved customers is developed and evaluated, the information obtained is provided to an origination database. Subsequently, offer files are prepared for the target group of customers. An offer file is a file containing all of the relevant information related to each offer for each customer. Based on the customer and loan information obtained by preparing the target list of customers, a price for each mortgage loan, which includes the costs of origination and associated fees, is prepared by the lender. The mortgage loan price is then supplied to the offer file.

The requisite legal disclosure information is also supplied to the offer file. These legal disclosures include Truth-in-Lending information and Good Faith Estimate data. A flood determination, escrow information, and a parcel number are also added to the offer file. The offer files are then reviewed in a quality control management system to ensure that the information and disclosures provided are correct. An offer letter is subsequently produced for each customer containing an offer based on information from the offer file. The offer letter is then sent to the customer. In the preferred embodiment, a third party vendor produces and mails these letters to the customer. However, it is contemplated that the lender may prepare and send these offer letters itself.

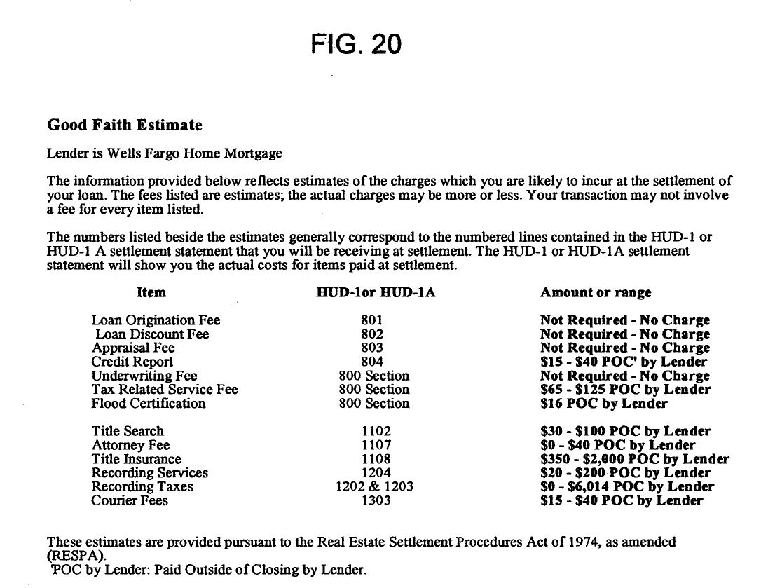

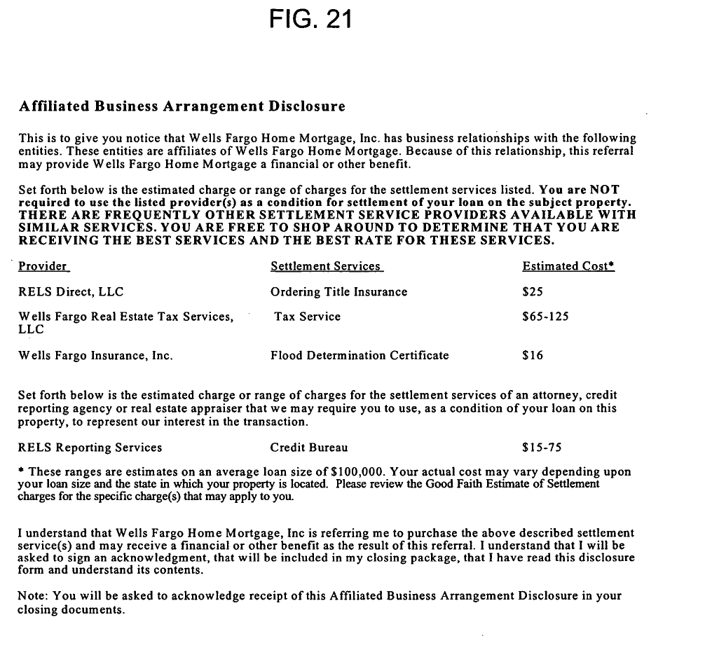

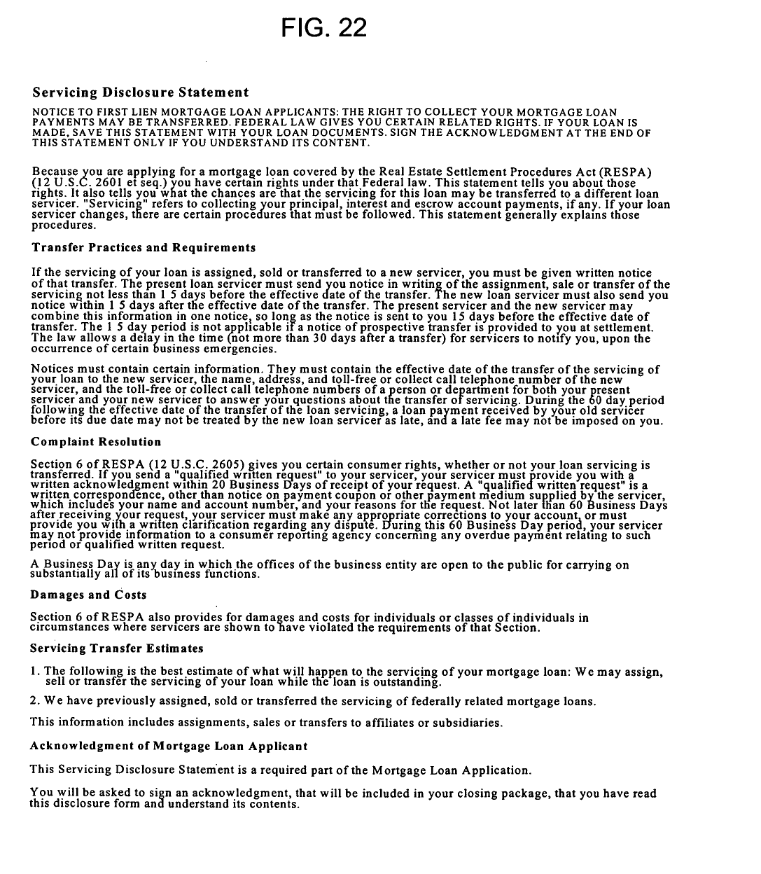

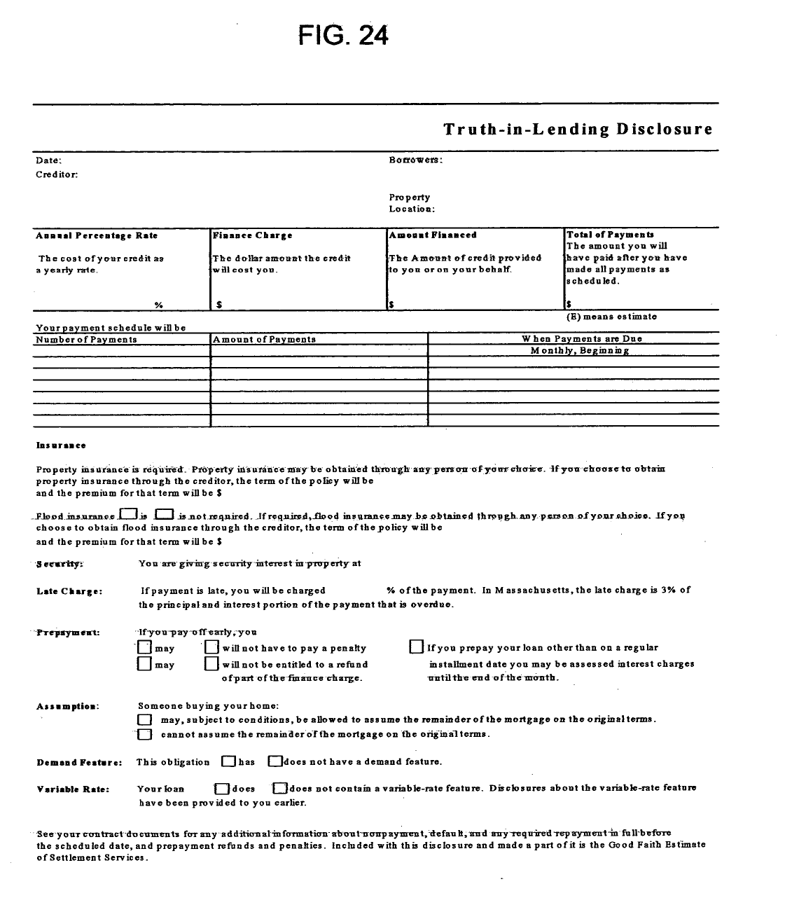

Offer letters of the preferred embodiment contain materials setting forth the terms of the refinanced mortgage loan, materials providing all required pre-acceptance disclosures, and instructions describing how the customer may accept the offer. Specifically, the materials setting forth the terms of the new mortgage loan may provide, but are not limited to, a mortgage term length, an interest rate, a mortgage loan amount, and a monthly payment amount. Examples of pre-acceptance disclosures provided in the offer letter include the Good Faith Estimate (FIG. 20) and Truth-in-Lending disclosures (FIG. 24). Additional pre-acceptance disclosures are also provided in the offer letter, such as: a comparison of the existing mortgage loan and the new loan offered, including specific amounts and terms, as well as the benefit of the new loan to the customer; instructions for the customer to follow to accept the offer; a guide for whether the customer should in fact accept the offer; common questions and answers regarding the offer to refinance; a servicing disclosure statement (FIG. 22), stating that the lender has the right to transfer the servicing of the mortgage loan to another party; the lender's affiliated business arrangement disclosure (FIG. 21); federally required disclosures; state specific disclosures, such as the customer's right to select a title insurance company, a notice that the lender is not acting as the customer's agent, or an anti-coercion notice; and other disclosures, including, but not limited to, how the customer's credit score is obtained. It is contemplated that one or more of these documents and disclosures may also, or alternatively, be incorporated into the closing package of the present invention. The instructions included in the offer letter provide the steps or process necessary for the customer to complete in order to accept the offer, including, but not limited to, how and when to contact the lender to accept the offer, and the information to be provided to the lender. The offer letter also requests a response by a certain date, provides, in some states, that the mortgage recording taxes will be paid by the lender, and provides an indication that a mortgage payment may be skipped. It is contemplated that these disclosures and the content of the offer letter will vary from state to state and can be tailored to a particular state, as well as the particular campaign offered by the lender. It is also contemplated that an unlimited response time may be provided. One of ordinary skill in the art would further understand that additional disclosures may be added, or disclosures may be removed from the list of examples presented without departing from the overall scope of the present invention.

The detailed offer letter allows for a streamlined closing. Particularly, the offer letter provides a unique presentation of documents and disclosures that sets up for a time compressed refinancing process and a reduced closing package. The customer only needs to contact the lender to accept the offer provided and complete a brief interview with the lender for the lender to send the customer a closing package to be executed by the customer. Furthermore, considering most of the information needed for the customer and the lender to proceed to closing is included in the offer letter, no commitment letter needs to be prepared or sent by the lender to the customer. Likewise, the customer is provided the specific mortgage amount and specific mortgage terms in the offer. Therefore, there is no need for the customer to provide further information or to prepare an application to determine the terms of any refinancing.

Prior to sending offer letters to the customers, the lender evaluates the information contained therein to ensure that proper legal and vesting language has been used in each offer letter. Proper legal language may include the appropriate property description or tax identification number. Proper vesting language may include the appropriate name and relationship of the customers to be provided the offer. When the lender is satisfied that the offer letters are valid, the offer letters are sent to the customers on the target list who meet all of the criteria for the campaign. The pre-approved customers on the target list are solicited by the lender, who sends an offer letter to each of these customers. In the preferred embodiment, the offer is sent by mail. However, it is contemplated that the offer may be sent by electronic means, such as by email or the Internet, sent by telephone, sent by courier, or delivered by hand. It is understood that the offer may be sent in any form that communicates the offer to the customer without departing from the overall scope of the present invention.

Contrary to current refinancing processes, all the underwriting steps (i.e., the filtering and evaluation of the customers) are performed by the lender prior to sending the offer to the customer. Therefore, the customer typically has not yet had any contact with, or approached the lender regarding the offer prior to the lender's preparation of an offer with specific mortgage loan terms. In one embodiment of the present invention, customers are notified of the coming offer prior to the offer being sent to the customer. Specifically, after pre-approval is completed, the origination database may trigger a voicemail system that sends a message to the customers in the target group to notify these customers of the coming offer. The voicemail system also notifies these customers one week after the offers have been sent. Alternatively, it is contemplated that notification may be sent verbally, such as by an individual representative contacting the customer by telephone, sent by mail, or sent by electronic means, such as by email or Internet message.

The offer files are also used by the lender to perform initial hedging of the risks associated with each potential mortgage loan. Specifically, initial hedging involves the hedging of any potential financial risk to the lender in the market based on the interest rate associated with these offers, such as a change in interest rate after a particular rate has been set and offered to a customer. The process of the preferred embodiment allows for a shorter hedge period than current refinancing processes. While current processes typically include a sixty or ninety day interest rate lock that the lender must hedge against, because of the streamlined features of the preferred embodiment, the present invention provides for a thirty or forty-five day interest rate lock, and therefore, a shorter hedging period than current methods. It is to be understood by one of ordinary skill in the art that the specific hedging time period is not meant to be limited to the listed range, and that any time period shorter than current methods would be acceptable for purposes of hedging interest rate risk for the present invention.

The offer files are also used by the lender for purposes of handling inbound communications from customers who receive these offers. Particularly, data relating to the individual customer offers is provided to a call center to assist the call center in providing individual service to the customer.

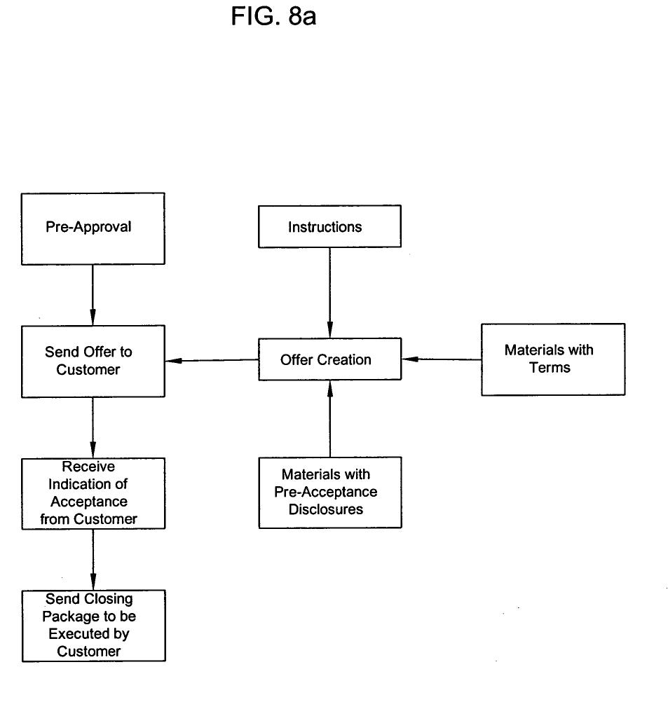

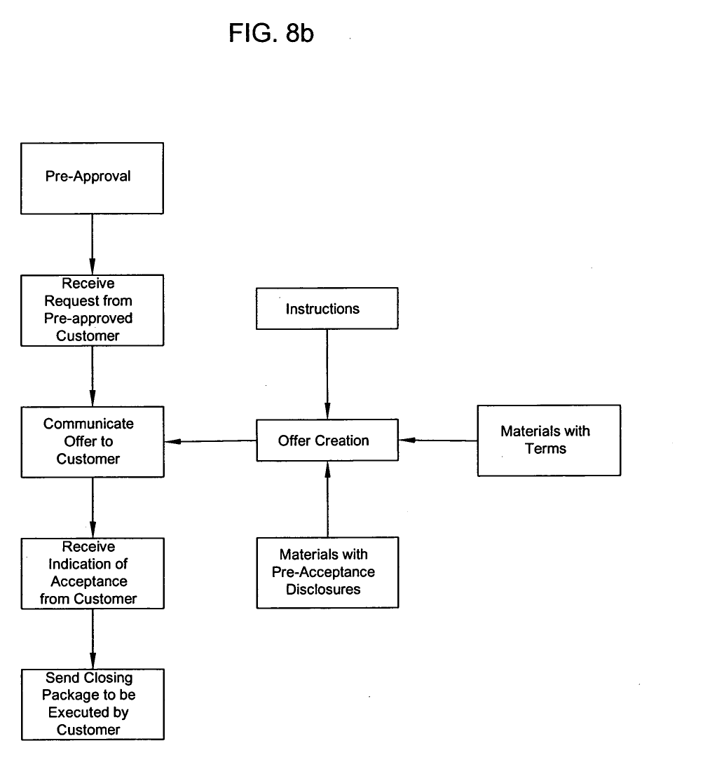

As can be seen from a comparison of FIG. 8a and FIG. 8b, while one embodiment of the present invention provides that the offer is sent to the customer, a different situation arises when the customer approaches the lender to request refinancing of a mortgage loan. In this situation, the customer is typically a pre-screened customer, as described hereinabove, who is seeking refinancing. However, any customer that approaches the lender may be acceptable for purposes of the present invention. The pre-screened customer approaches the lender, often in person, and requests refinancing. In response, the lender may provide a verbal or written offer to the customer at the time of the request, or at a later date if appropriate. The offer, as discussed herein, provides materials setting forth the terms of the refinanced mortgage loan, materials providing all required pre-acceptance disclosures, and instructions describing how the customer may accept the offer. The customer may simply accept or decline the offer. If the customer accepts the offer, by any means of communicating the acceptance of the offer, the process proceeds as if the offer was sent to the customer and accepted. Thus, the pre-approved customer may obtain the benefits of the present invention on demand in addition to by solicitation of the customer.

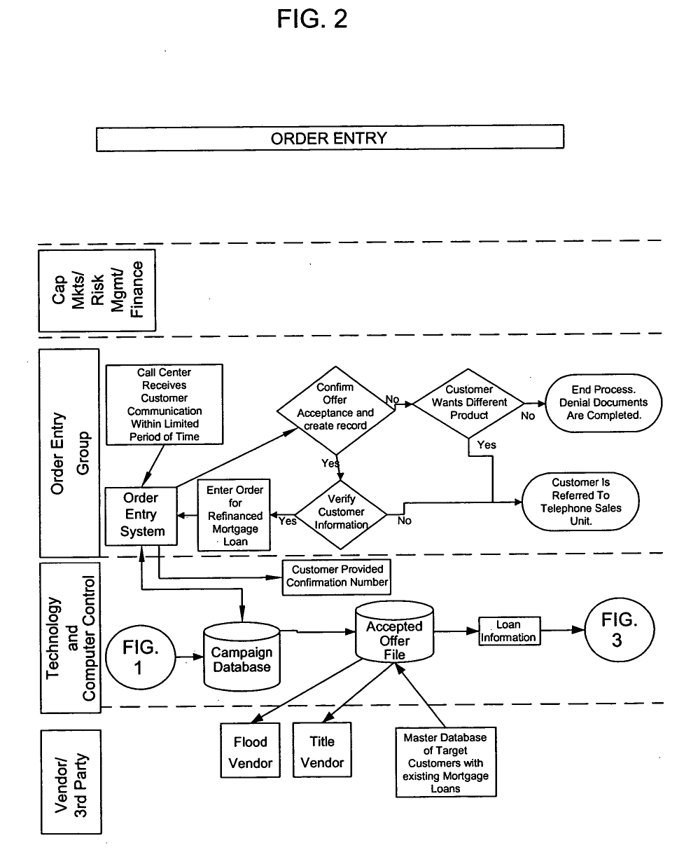

In the preferred embodiment, after the offer is provided to the customer, loan information for each customer is transferred from the origination database to the campaign database which manages information associated with a particular campaign (FIG. 2). The campaign database contains an updateable campaign file. The campaign file stores closing, rescission, and expiration dates for each campaign. These dates are used on documents prepared during the refinancing process and to establish closing, rescission, and expiration dates for individual loans. After the loan information is transferred to the campaign database, the campaign database supplies the loan information to an order entry system to prepare for receipt of a communication from the customer.

The offer of the preferred embodiment is presented by the lender to the customer for a limited period of time. In other words, the customer must notify the lender of the customer's acceptance of the offer by a certain date. After the specified date, the offer expires and the lender may not be able to refinance the customer's mortgage with the same terms as presented in the offer. The time period for acceptance will vary depending on the particular campaign established by the lender. It is also foreseeable that an offer could be presented to a customer that does not need to be accepted within a limited timeframe.

The process of refinancing a mortgage loan of the present invention continues when the customer accepts the offer to refinance within the specified time provided for acceptance. FIG. 2 shows the process whereby the lender receives a communication from a customer accepting the offer and the corresponding processing of the acceptance that is performed by the lender. Customers, upon receipt of the offer letter, respond by communicating to the lender an indication of acceptance or refusal of the offer. The communication from the customer to the lender of the preferred embodiment is by telephone or Internet. However, one of skill in the art would understand that any form of communication that would communicate or indicate the acceptance of the offer would be acceptable for the purposes of the present invention.

When the customer contacts the lender to accept the offer, a call center receives this communication from the customer. The call center of the preferred embodiment is an individual representative of the lender responding to telephone calls or an Internet site. Alternatively, the call center may be a telephone automated voice response system, or electronic means, such as email or an Intranet site. Additionally, the call center may be an individual representative of the lender who meets in person with customers. In one embodiment of the present invention, an individual representative of the lender receives a communication from the customer and is assisted by a programmable computer implementing a software program in carrying on a dialogue regarding the offer provided to the customer. Particularly, the computer software provides the call center representative questions for the customer and answers to the questions presented by the customer. The call center is also contemplated, in one embodiment, to change the terms of a mortgage loan offer during the communication with the customer, including, but not limited to, negotiating interest rates with the customer for a particular mortgage loan offer, and offering alternate term mortgage lengths to the customer, in which case, the offer letters associated with such offers providing for different term options and interest rates would be modified to include additional disclosures, such as, two or more Good Faith Estimates (FIG. 20) and Truth-in-Lending disclosures (FIG. 24).

If the customer accepts the offer to refinance a mortgage loan, an order based on this communication is entered in the order entry system for the particular mortgage loan offer. The order entry system of the preferred embodiment is a software program implemented by a programmable computer that provides fields for the entry of specific information provided by the customer. Particularly, when the call center receives the customer's communication, the call center utilizes the order entry system to collect information provided by the customer. The order entry system of the preferred embodiment is a means by which the lender creates a record of the customer's acceptance of the offer and obtains further information from the customer regarding both the customer and the particular mortgage loan. The order entry system is an electronic medium, including, but not limited to, a computer software program, or an Internet program that is completed by the customer. However, a printed document to be completed by an individual lender or call center representative during the lender's communication with the customer with information provided by the customer may also be used without departing from the scope of the present invention. It is also contemplated that this order entry system may be completed by the individual customer by him or herself, or alternatively, with the assistance of a call center representative.

The order entry system confirms that an offer to refinance a mortgage loan has been made to the customer and the customer's acceptance thereof. Because the customer provides a verbal or written acceptance or acknowledgement of the questions and information accompanying the offer and the order entry system, no loan application needs to be completed by the customer. When a customer contacts the lender's call center to accept an offer to refinance a mortgage loan, the call center enters a customer number and a loan number associated with a particular offer into the order entry system. The order entry system, in return, provides the call center with the customer's current loan information, and information corresponding to the new loan that would be created upon the customer's acceptance of the offer to refinance. The order entry system provides information to the call center to answer questions posed by the customer, as well as a series of questions to obtain additional customer declarations. These declarations are obtained from the customer, in addition to any co-borrowers. In the preferred embodiment, the series of questions is used to obtain customer declarations, including, but not limited to: outstanding judgments; a prior declaration of bankruptcy; whether the customer is a party in a foreclosure action or a party in a lawsuit; whether the customer has been delinquent on a loan; whether alimony, child support, or separate maintenance payments are required of the customer; whether the customer is a co-signer on a note; the citizenship of the customer; whether the property is a primary residence or a second home; whether the property is for investment or rental; the monthly income of the customer; the customer's birth date; and the customer's marital status. Further information is also obtained from the customer relating to the personal history of the customer and the particular mortgage loan and property involved in the refinancing process. The information collected from the order entry system also includes data required for compliance with industry regulations, such as the lender's duty to collect optional fair lending information involving race and gender from the customer. Further examples of information obtained from the customer are: a determination of whether the relationship between spouses or co-owners of a property is listed correctly in the documents; whether a customer's status has changed; or whether the current financial information used to establish the offer is correct. The order entry system instructs the call center to verify the customer's personal information, including full name, social security number, any change of ownership interest, mailing address, and phone number. It is noted that one of ordinary skill in the art would understand that any question pertinent to evaluating an individual customer for a lender's purposes could be asked as part of the order entry system. The answers to these questions are used to evaluate whether the lender is still able to provide the refinancing offered to the customer. Offer accepted files are then prepared with the information collected from the customer. These offer accepted files are compared to the master database for errors.

Once the lender confirms that the customer's information is correct, in the preferred embodiment, the lender provides the customer with a confirmation number. This confirmation number is necessary for the customer to complete the method of refinancing a mortgage loan. The confirmation number will be requested as part of any further customer initiated contacts to validate the customer.

It is contemplated that a customer may be denied refinancing based on the evaluation of the customer's responses obtained by the order entry system, such as when the ownership of the property is listed incorrectly in the original offer. Alternatively, a customer may choose not to accept an offer, and instead may request a different mortgage loan arrangement from the lender. When a customer is ineligible for an offer in the preferred embodiment, or chooses not to accept a particular offer, the customer is referred to a telephone sales unit. This sales unit provides alternative choices to the customer, such as a loan more suited to the customer's particular situation. Furthermore, if the customer calls and then chooses not to accept a particular offer, government required documents are completed to explain why the customer terminated or rejected the offer.

As seen in FIG. 2, when the mortgage loan is accepted and the necessary information is entered into the order entry system, the loan information in the accepted offer file is transferred back to the campaign database, which tracks the accepted offers and relevant information related to each accepted offer. The accepted offer files are also supplied to a title vendor to inform the title vendor of those individuals who have accepted the lender's offer. The title vendor insures the property against prior claims of ownership. The preferred embodiment of the present invention does not involve obtaining traditional title commitments and title policies subsequent to closing. Instead, a master policy with certificates is obtained by the lender from the title vendor. Furthermore, considering the preferred embodiment provides a method of refinancing a mortgage loan, a previous title search has already been performed for the first mortgage on the property for each customer. Therefore, the title vendor may or may not perform a title search and does not supply the lender a title search, but instead simply notifies the lender of a list of new mortgages to insure. For this list of new customers, the title vendor verifies vesting and credit information. It is noted that due to certain state requirements or particular lender campaigns, alternative embodiments may be used that include title search and insurance services, including title commitments. Furthermore, the title vendor of the preferred embodiment insures the refinanced mortgages as first mortgages using negotiated processes such as processes for obtaining subordination agreements for any mortgages using the same lender for the second time to refinance.

It is also noted that during traditional processes, the lender typically attaches a legal description of the property to the mortgage documents. However, in the preferred embodiment, the title vendor attaches the legal description of the property to the mortgage documents based on the tax parcel identification numbers the lender supplies, reducing the lenders overall time and expense.

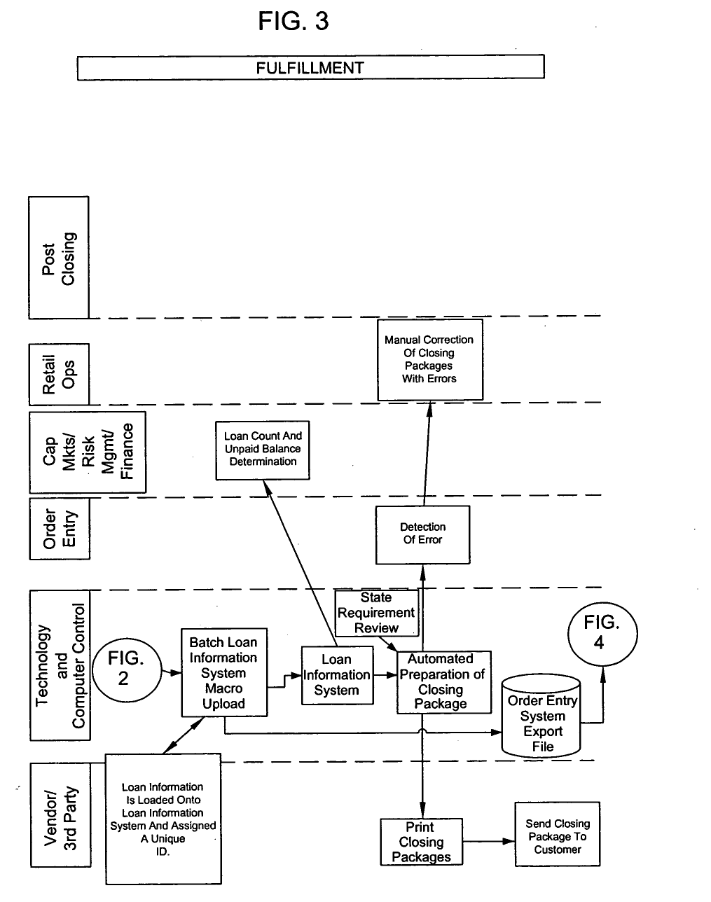

As shown in FIG. 3, after the title vendor is provided the accepted offer files, the loan information generated from the order entry system and accepted offer files is transferred into the lender's loan information system and a unique identification is assigned to the file for purposes of tracking this file through the process of obtaining refinancing of a mortgage loan.

The information in the loan information system may then be transferred to the lender's risk management system. The risk management system hedges the accepted offers against the risk of interest rate fluctuation to the lender. Furthermore, the information from the loan information system is used to determine the number of customers and loans affected, as well as the overall unpaid balance associated with the mortgage loans offered to each customer in order to forecast the financing needed to pay off the existing mortgage loans and the funding that will be needed to support the new loans.

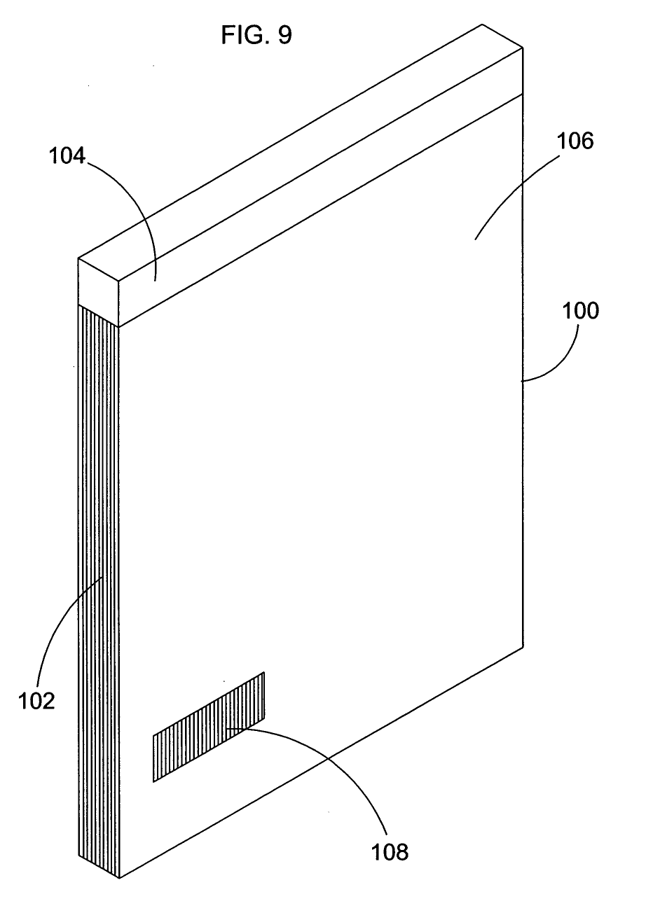

In addition to the lender's risk management, FIG. 3 represents the process of fulfillment of refinanced mortgage loans offered to pre-approved customers. Fulfillment involves the preparation of closing packages to be sent to the customers. Specifically, the documents to be completed and executed by the customer for completion of the mortgage loan agreement must be collected and prepared by the lender. In the preferred embodiment, the documents included in the closing package are reduced significantly from those provided in current closings. Particularly, without altering legal requirements and other protections, the documents are reduced in number. The closing package of the preferred embodiment also includes a detailed description of the process and procedures necessary for filling out and executing the documents contained in the closing package, instructions for a notary, as well as a return-addressed envelope (see generally FIGS. 9 through 24). The format and instructions of the closing package provide specific guidance to the customer to ease the customer's burden in completing and executing the closing documents. Furthermore, contrary to traditional closings, no records are requested from the customer to complete the closing package.

Referring to FIGS. 9 & 10, the closing package 100 of the preferred embodiment comprises a bound set of documents, namely, a closing workbook 100. It is noted that the specific reference numerals disclosed herein refer specifically to the embodiments disclosed in FIGS. 9 & 10 to assist in the detailed discussion of the closing package, while prior and subsequent references to these items refer generally to these closing packages and documents as they are used with the method of refinancing a mortgage loan of the present invention. The binder 104 used to bind the set of documents 102 can be any conventional means used to bind loose pieces of paper or documents, including but not limited to, staples, adhesive, ring, or spiral binding. Furthermore, the binder 104 can be located anywhere on the closing package workbook 100 without departing from the scope of the invention, so long as such binding does not interfere with the text of the attached documents 102. As bound documents, the likelihood the documents will be missed or lost during the process of executing the documents, or returning the documents to the lender, or during processing of the documents by the lender is significantly diminished. A cover 106 is also provided as the first bound article for protection of the documents 102 in the closing package 100. The cover 106 also identifies the package of documents, provides an esthetically pleasing appearance, and identifies the specific customer for whom the closing package 100 was created. Furthermore, a processing notation 108 is provided on the closing package workbook 100, and specifically on the cover 106, as well as on one or more of the closing package documents 102, 110, to allow for easy scanning and tracking of each closing package workbook 100 and closing document 110 by the lender. The processing notation is associated or linked with a specific customer's information, so that each customer's closing package 100 and documents 102 can be located and tracked in the lender's systems. Preferably, the processing notation is a bar code 108 attached to the closing package workbook 100 or closing package documents 102, 110. The bar code 108 may also be scanned, and allows the lender to quickly determine whether closing documents or closing packages are missing. The bar code 108 also increases the rate of processing for the lender. While a bar code 108 is illustrated, it is further contemplated that other means of marking or tracking these documents would be acceptable for purposes of the present invention. Perforations 112 provided across a portion of the closing documents further increase the rate of processing by allowing the lender to easily remove the closing documents from the closing package workbook. However, any means of making a document 110 easily removable from the binder 104 would be acceptable for purposes of the present invention.

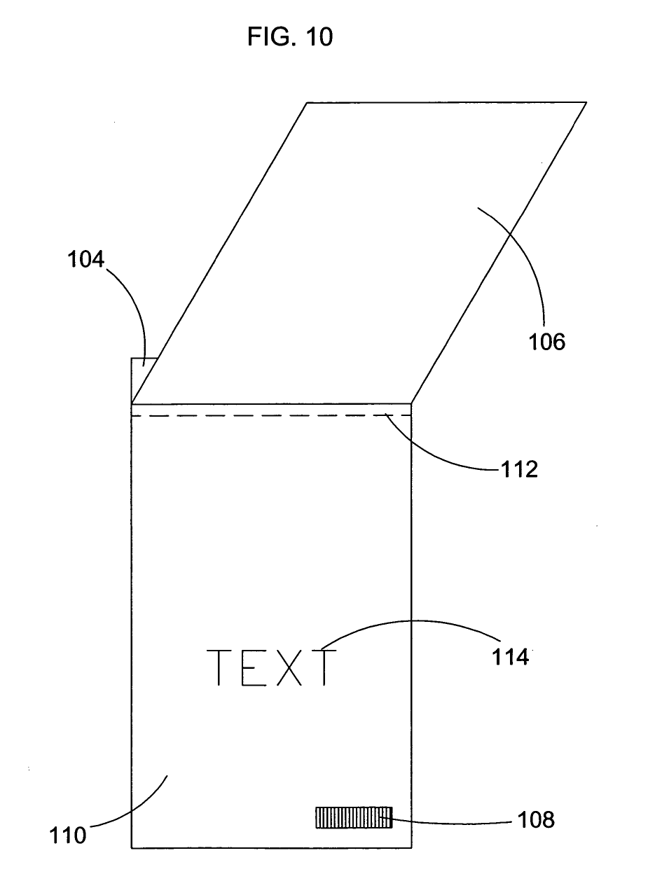

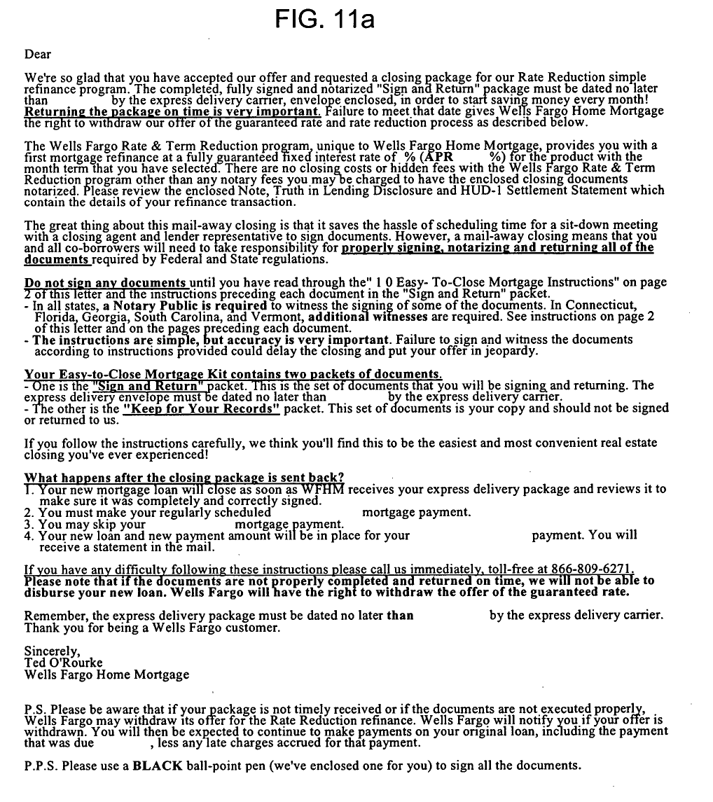

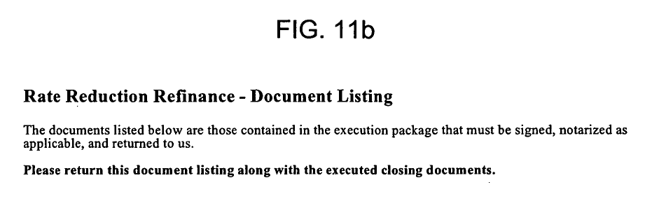

As specifically shown in FIG. 10, the documents 102, 110 of the closing package 100 are accessed by opening the cover 106. FIG. 10 shows the general format of a closing package document 110 attached within the closing package 100. Each document 110 within the closing package 100 contains means to remove the document 112 from the closing package 100, such as a perforation. Each document also contains text 114, which will be described in more detail herein and shown in FIGS. 11 through 24. Generally, the text 114 is an instruction, a checklist, a note, a mortgage, a rider, an acknowledgment, an agreement, or a disclosure. Furthermore, one or more of these documents 110 contain a processing notation 108 to record and track the specific document in the lender's systems.

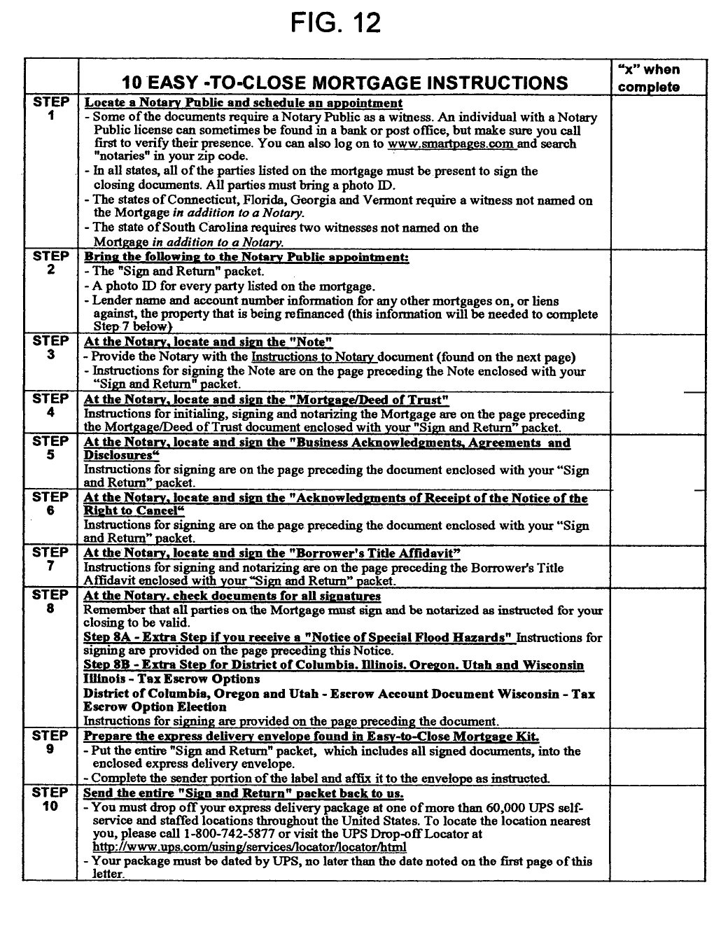

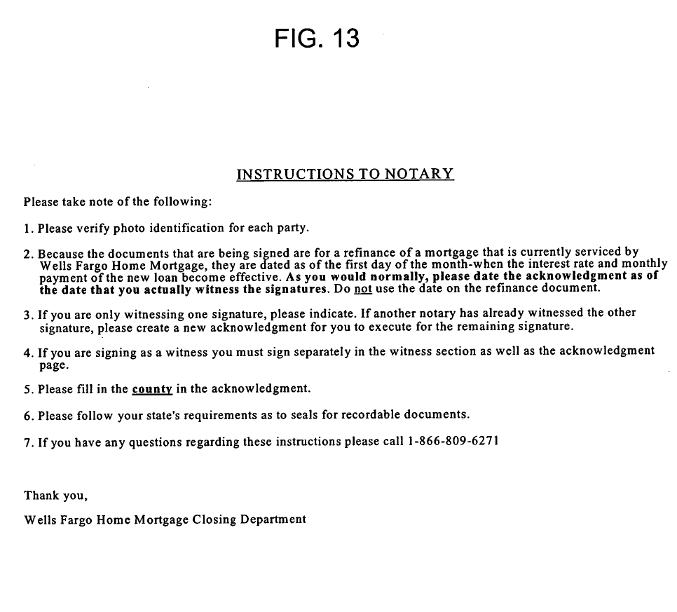

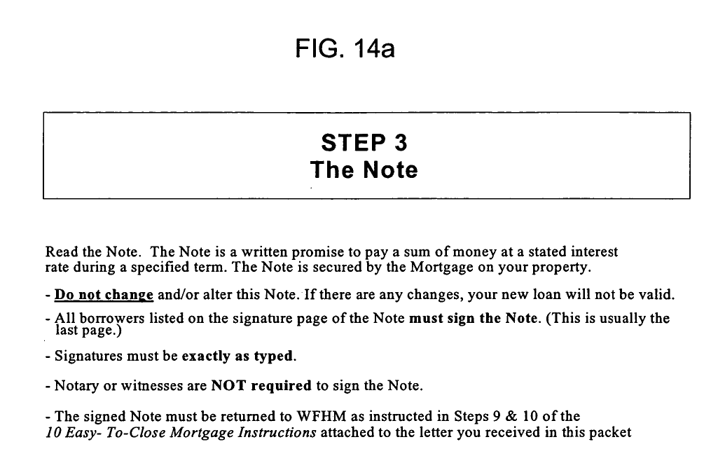

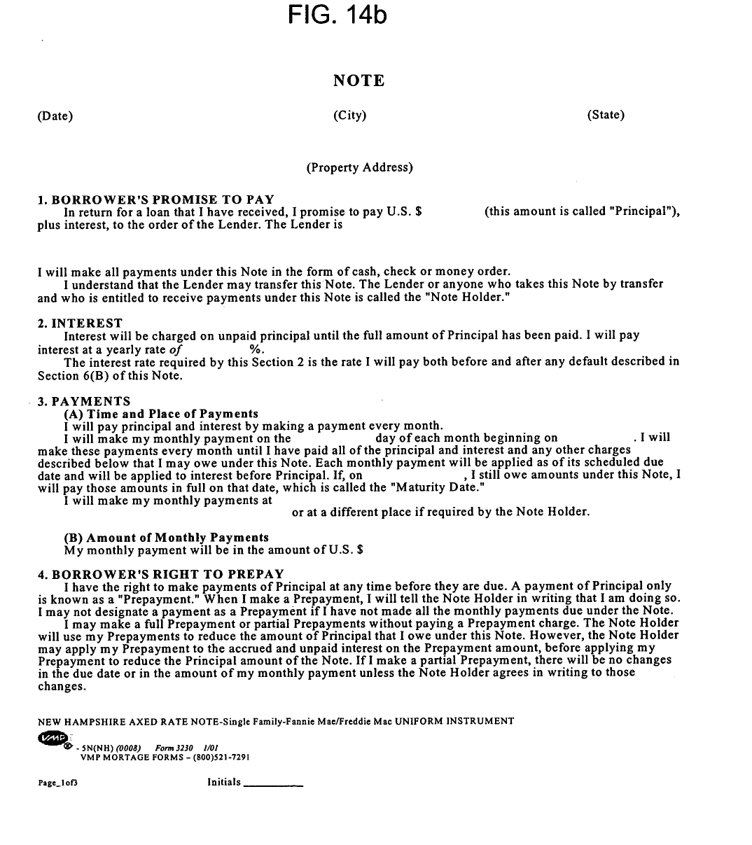

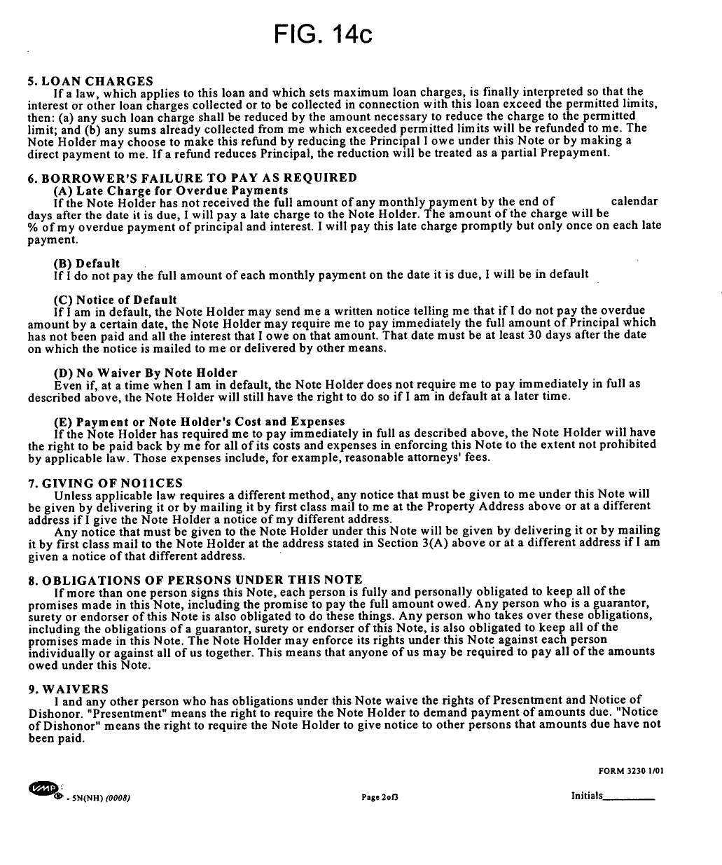

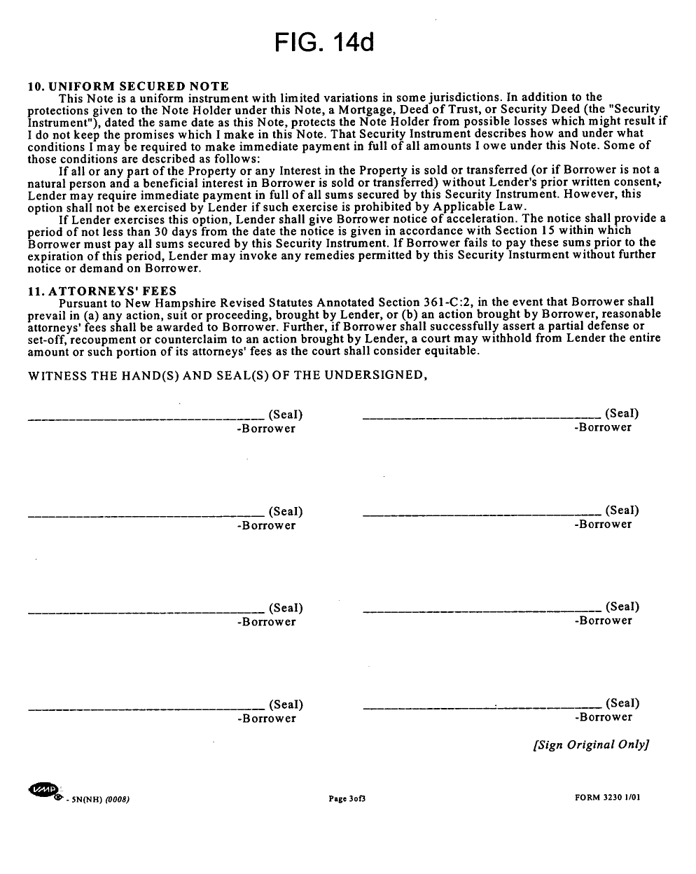

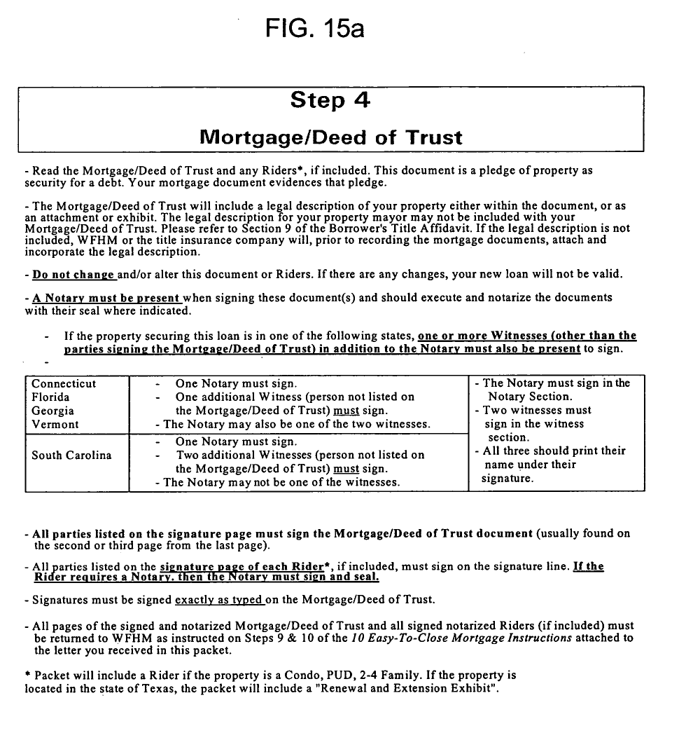

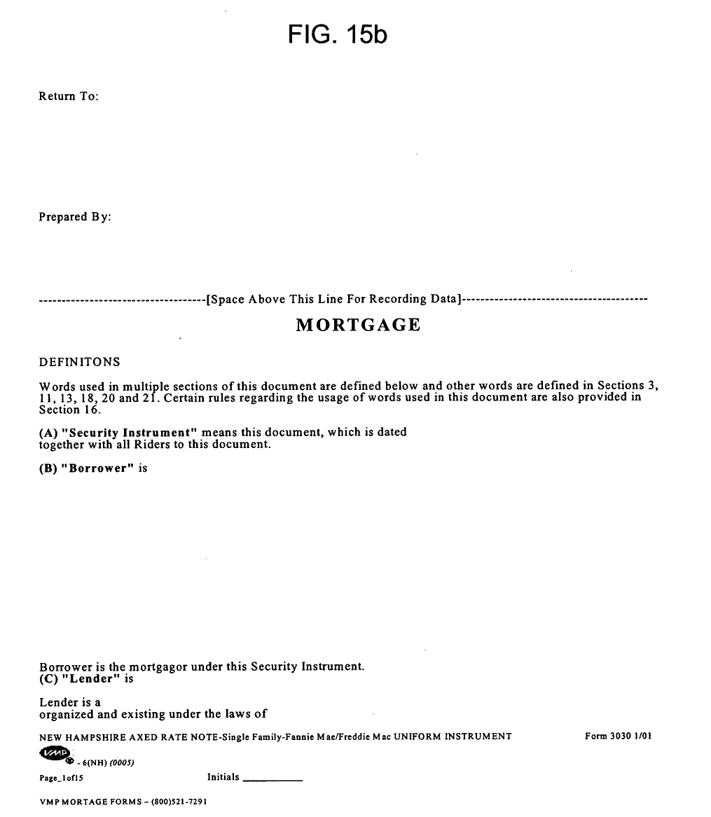

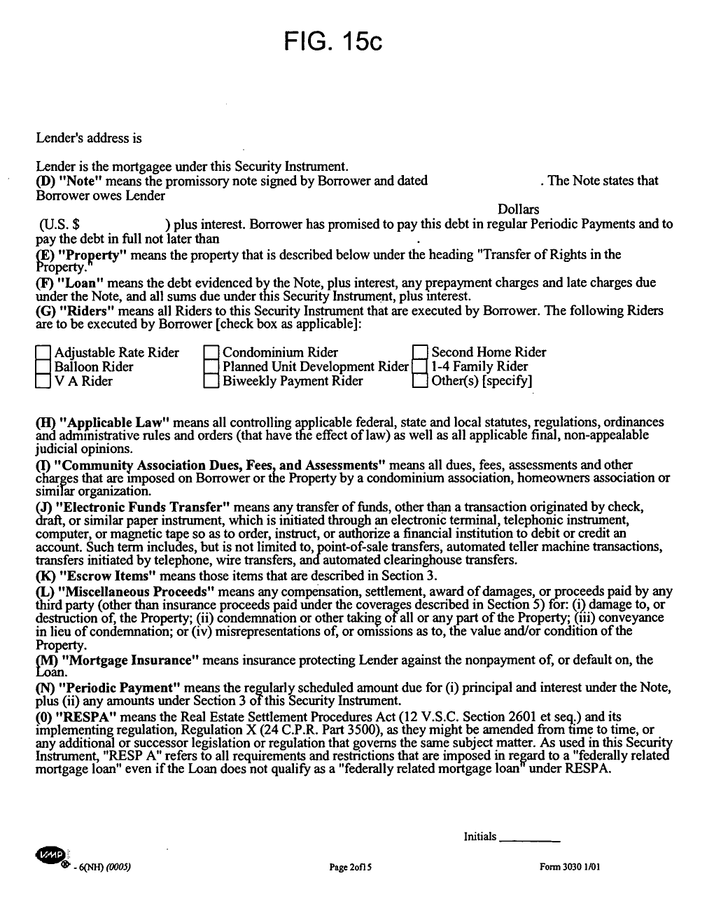

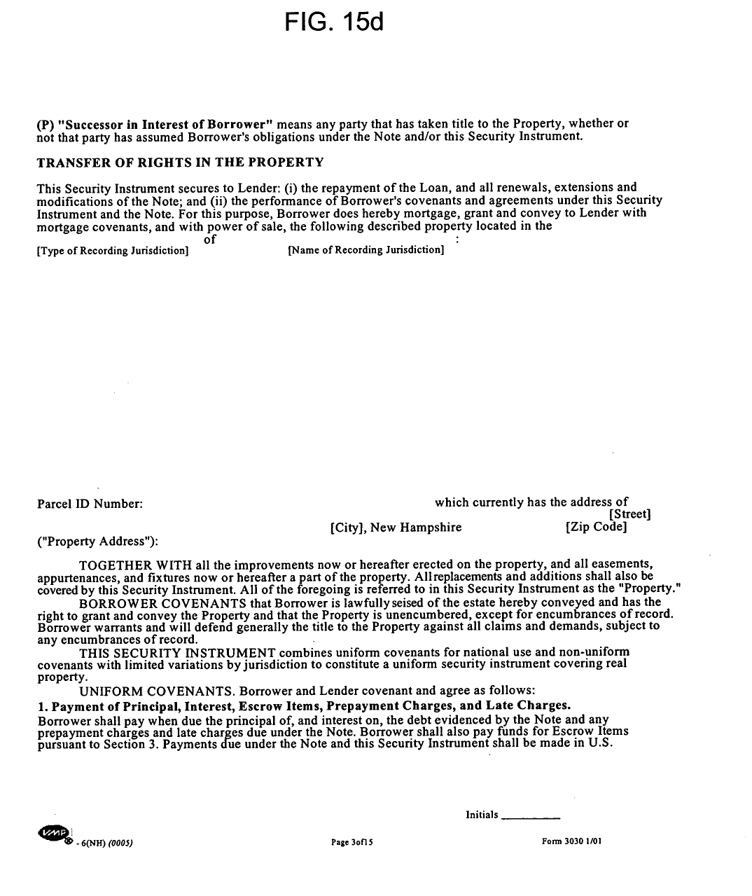

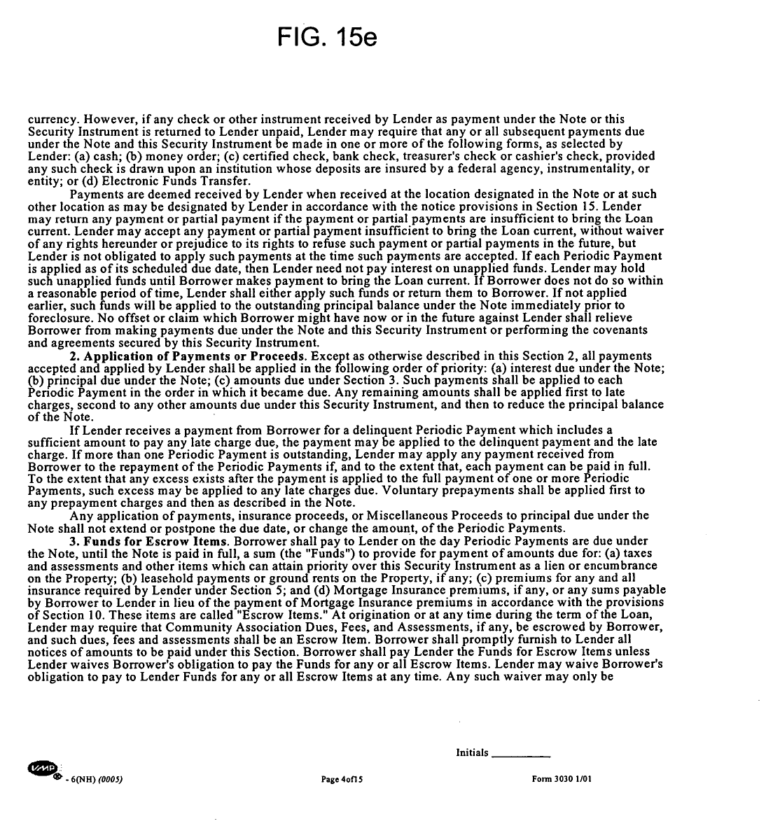

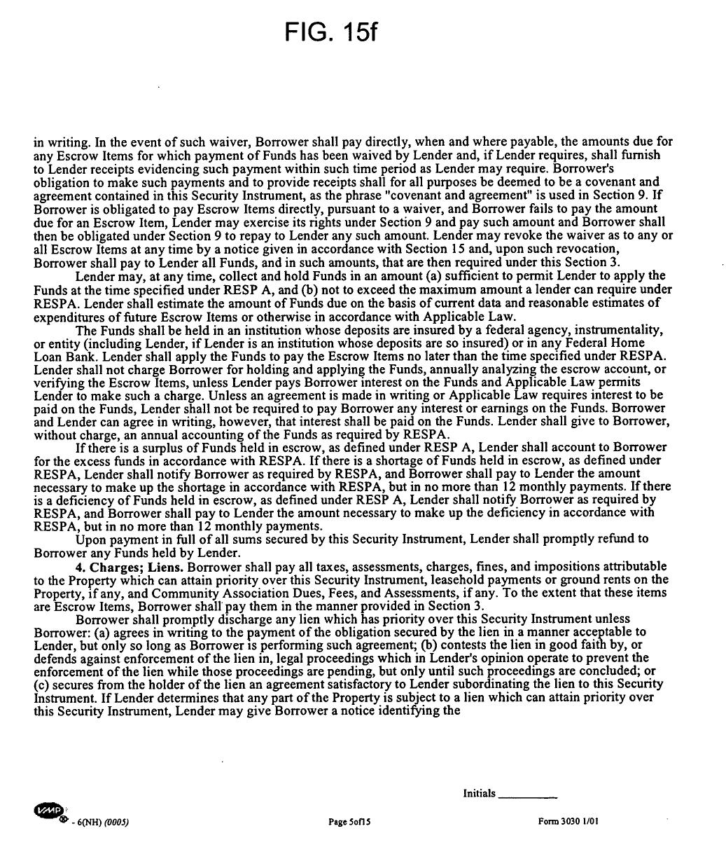

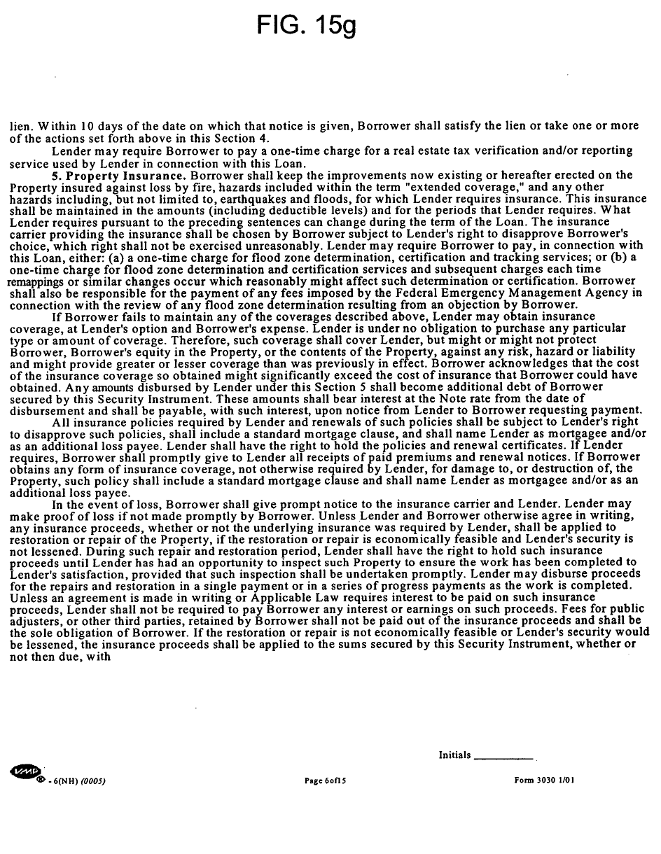

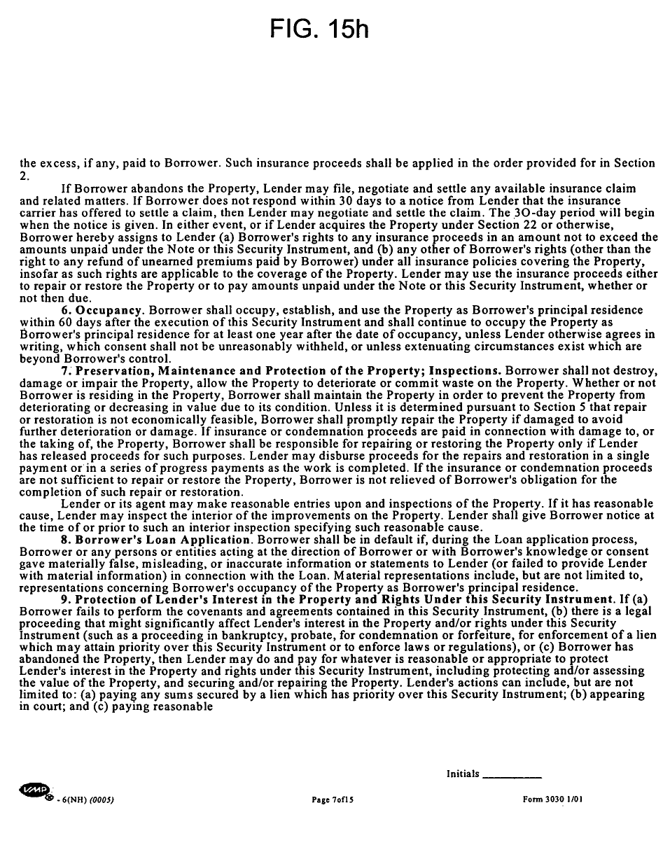

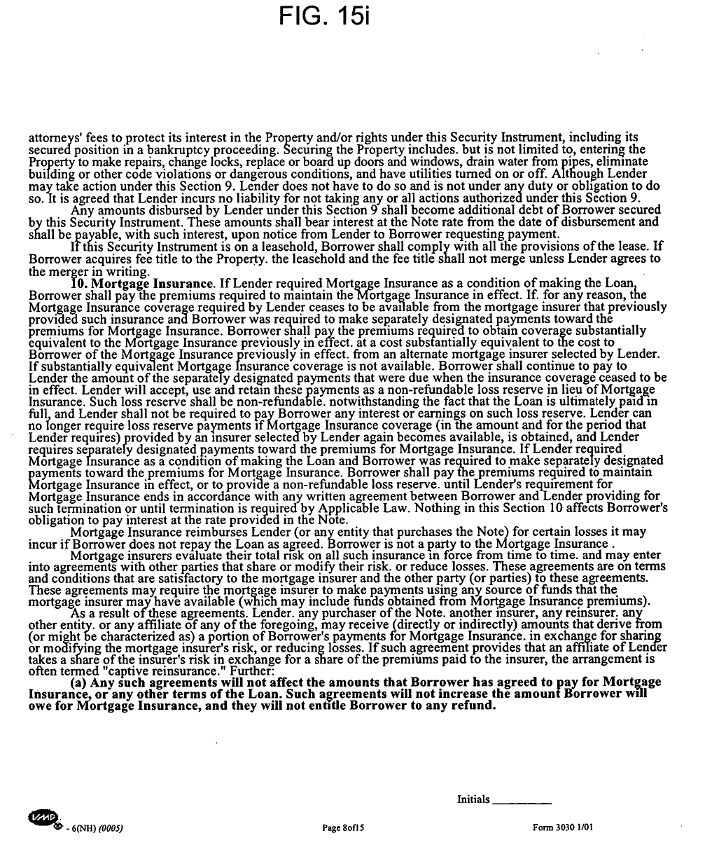

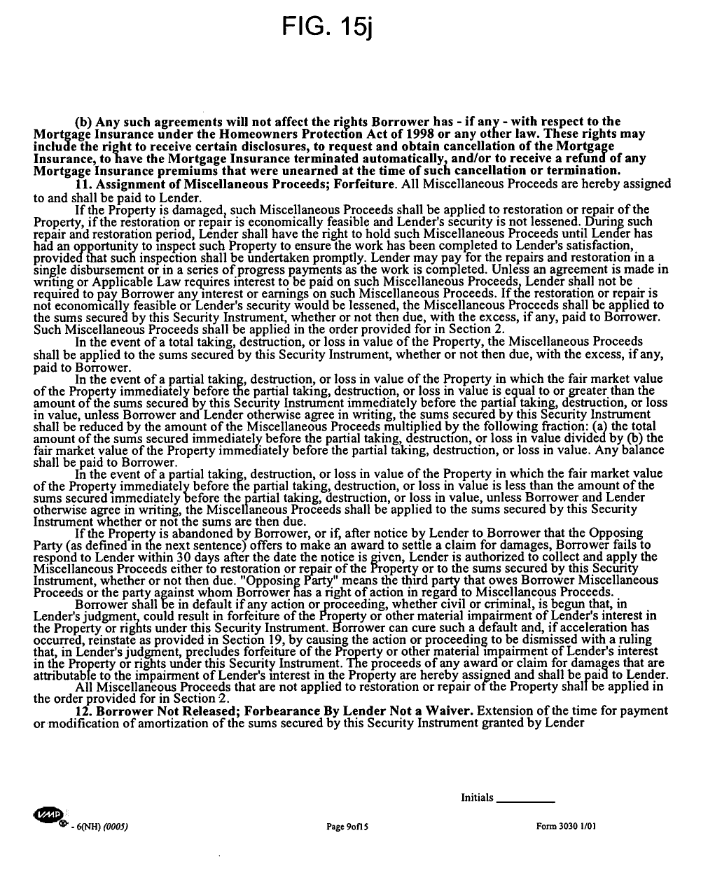

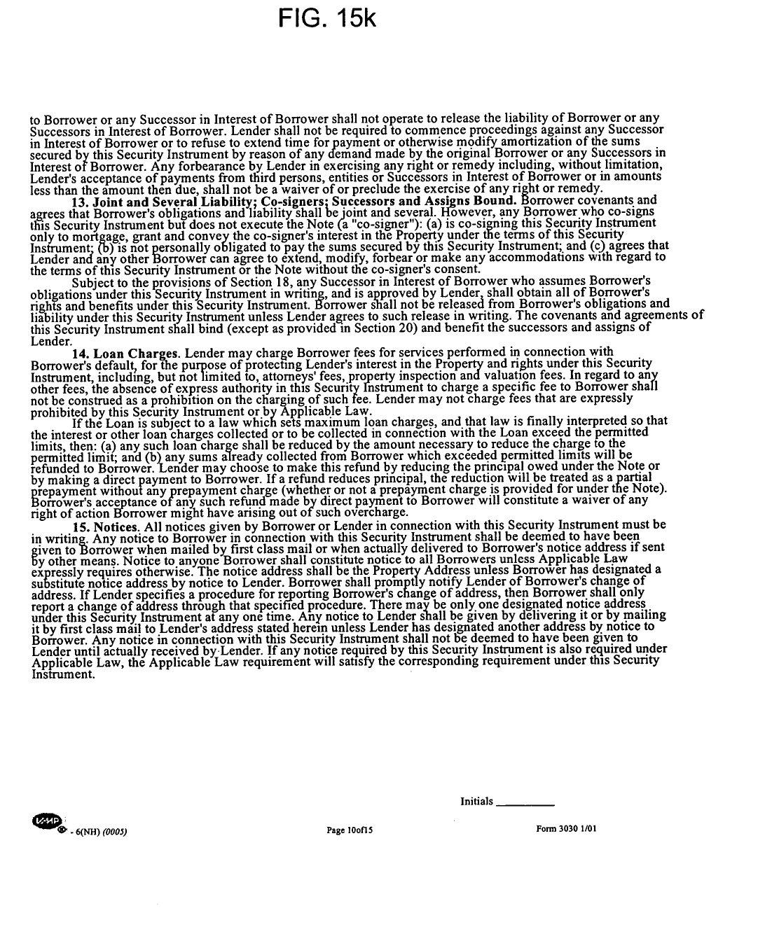

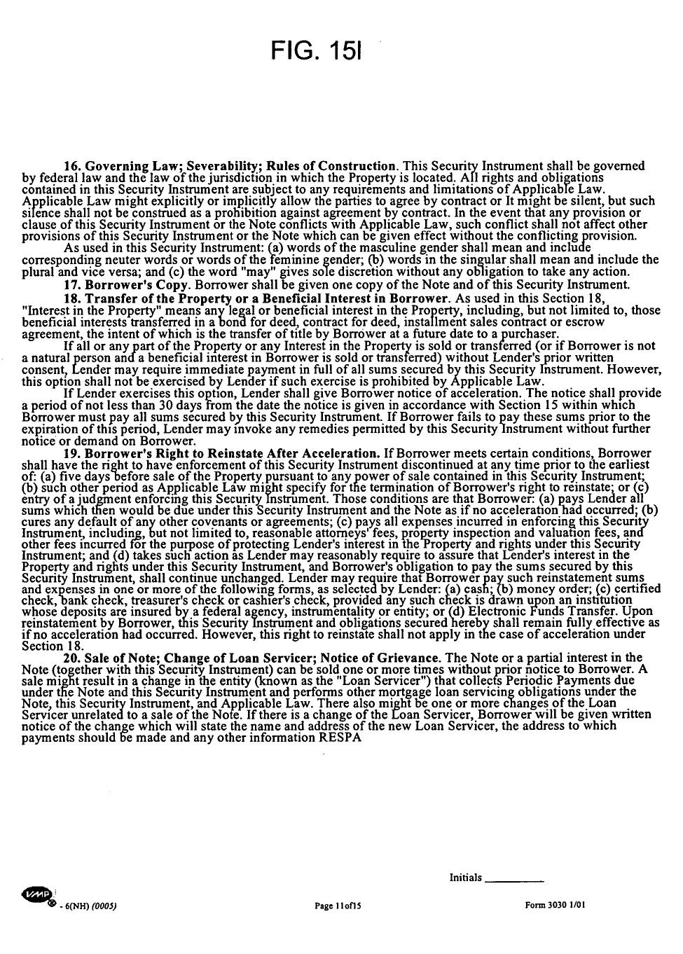

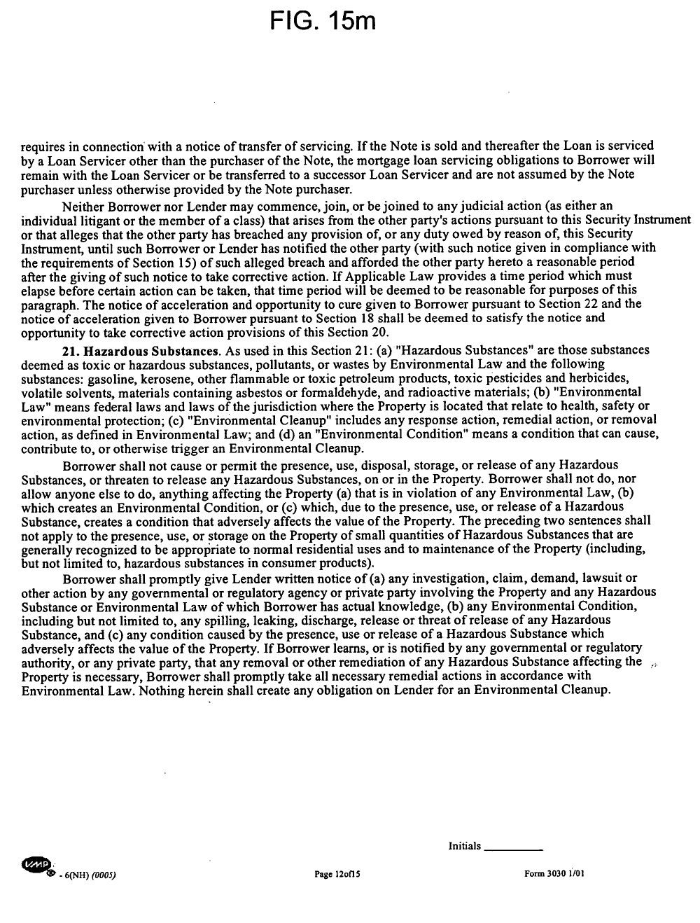

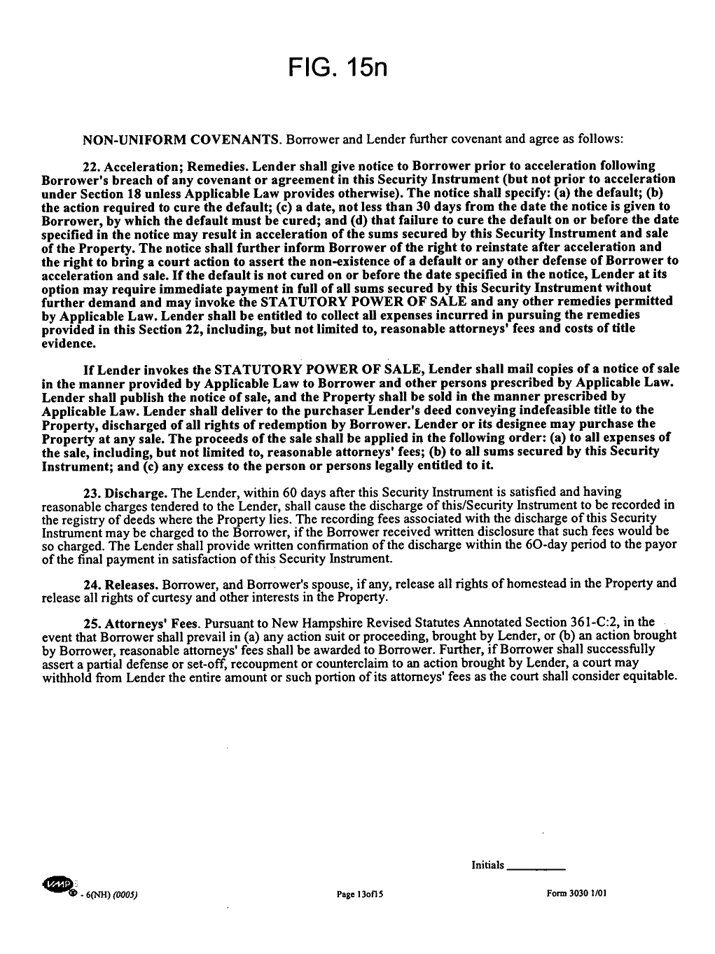

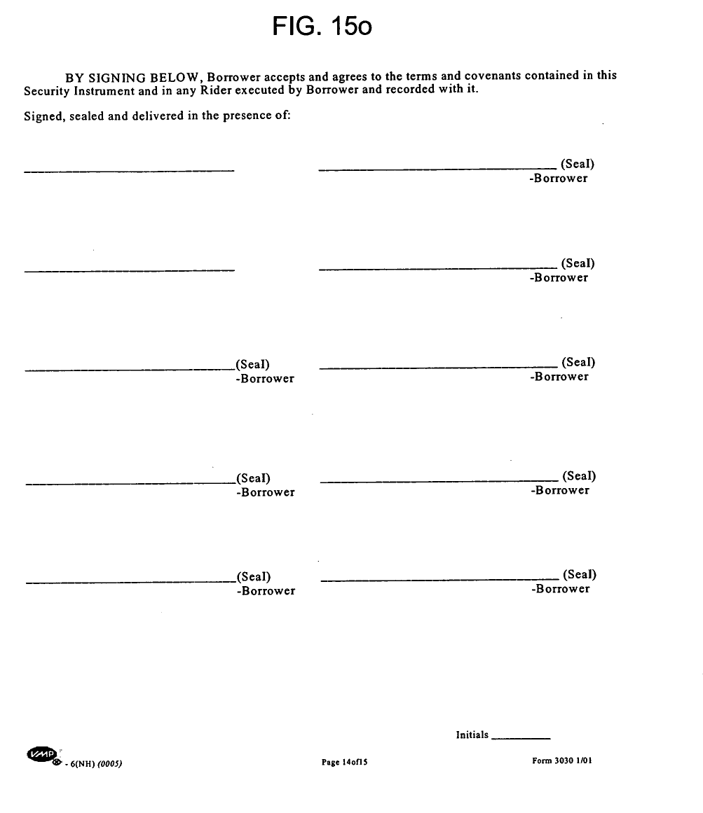

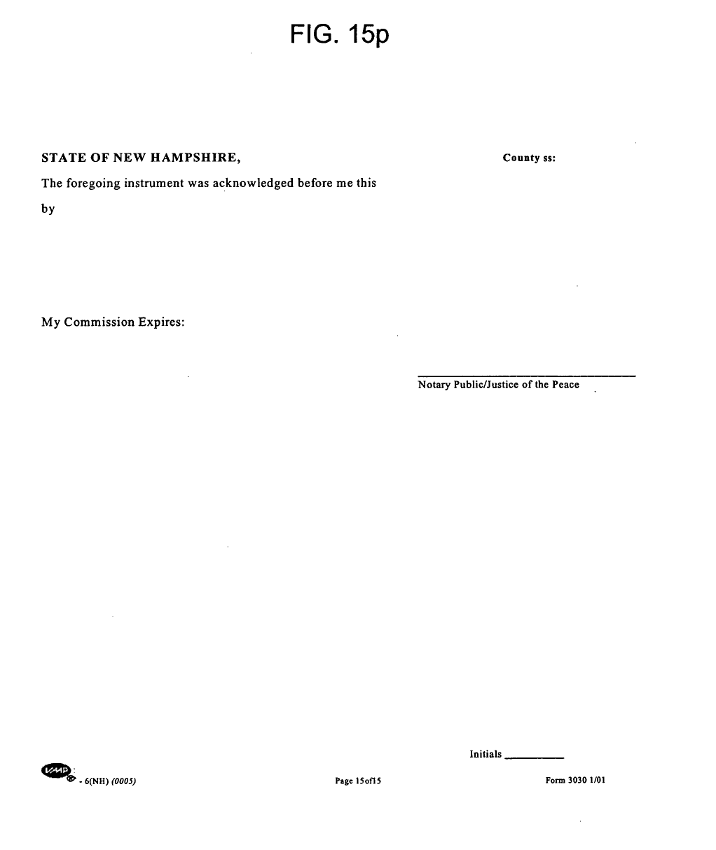

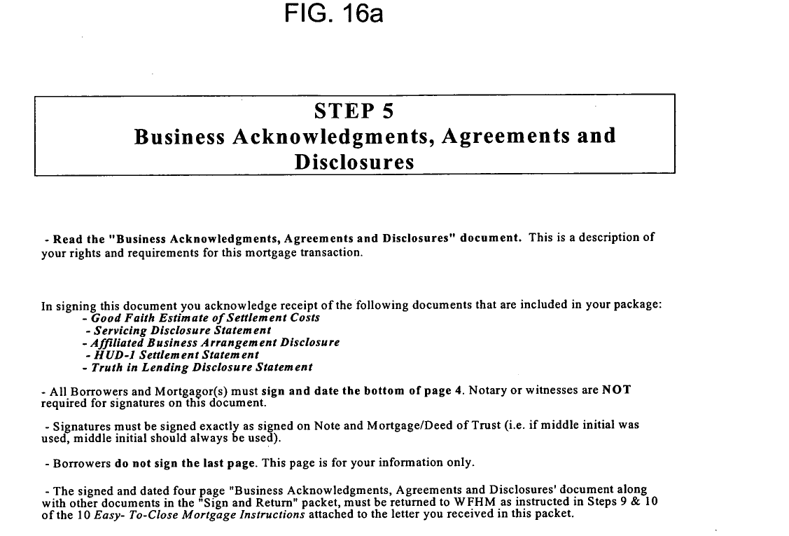

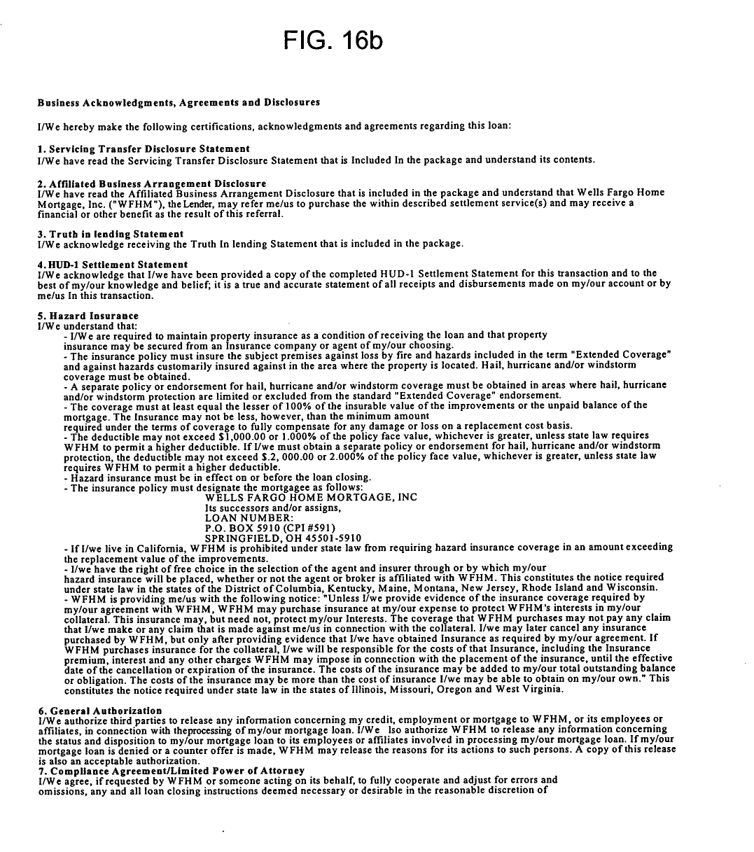

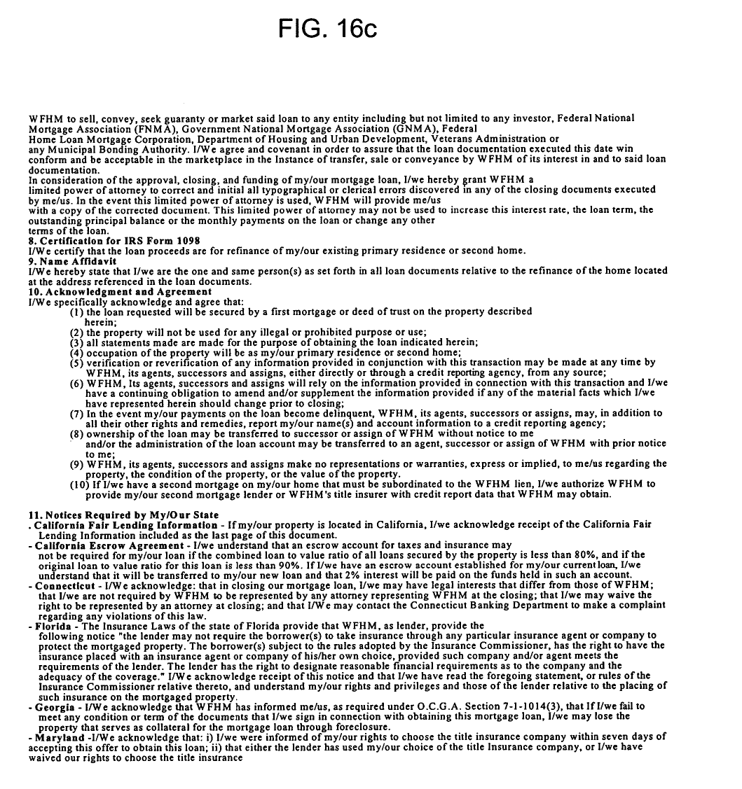

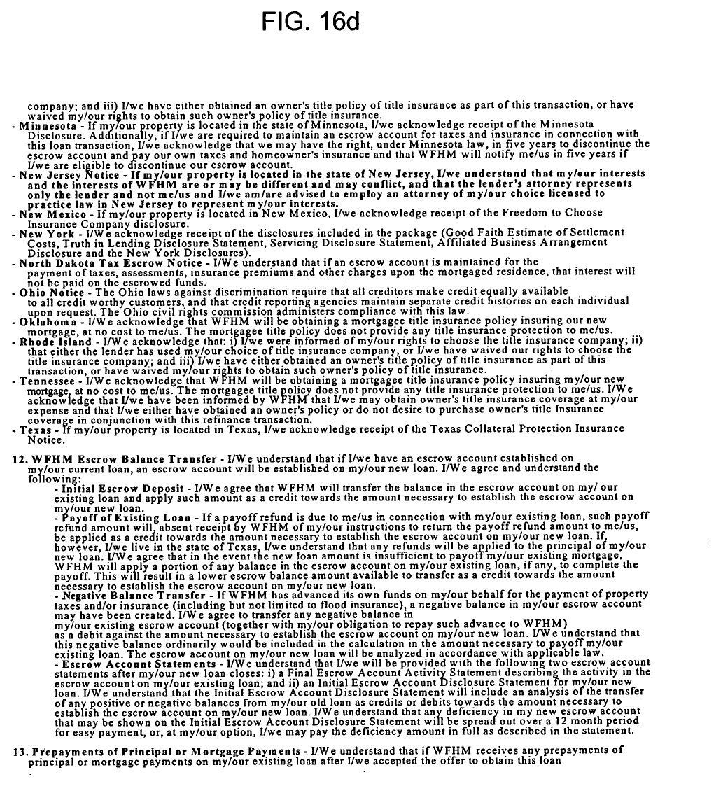

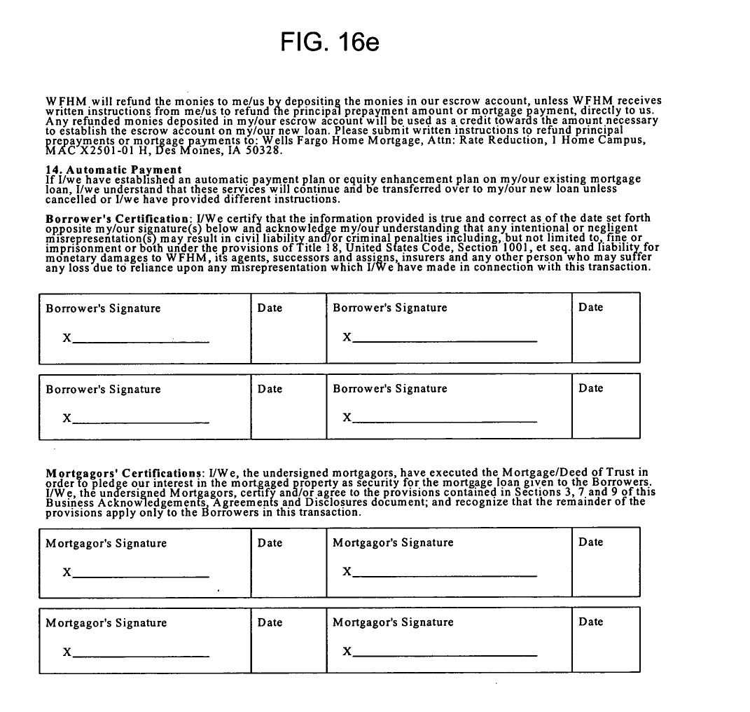

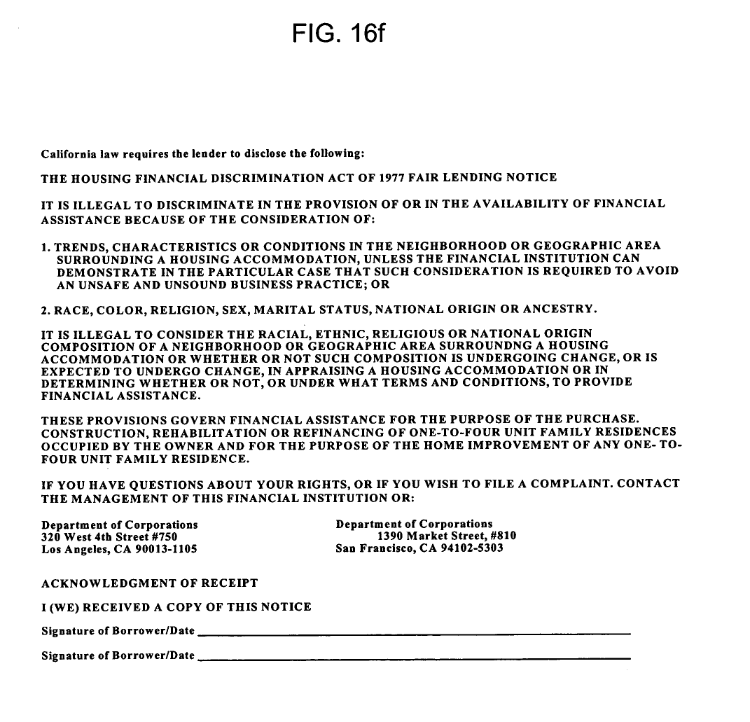

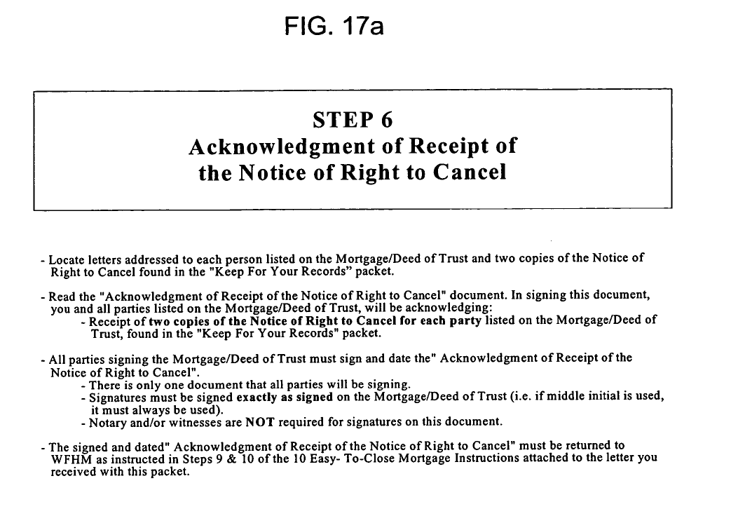

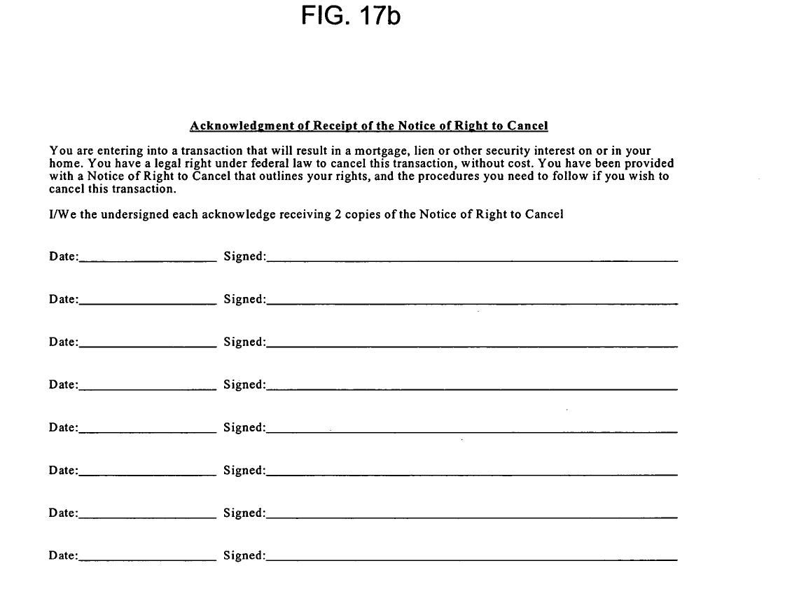

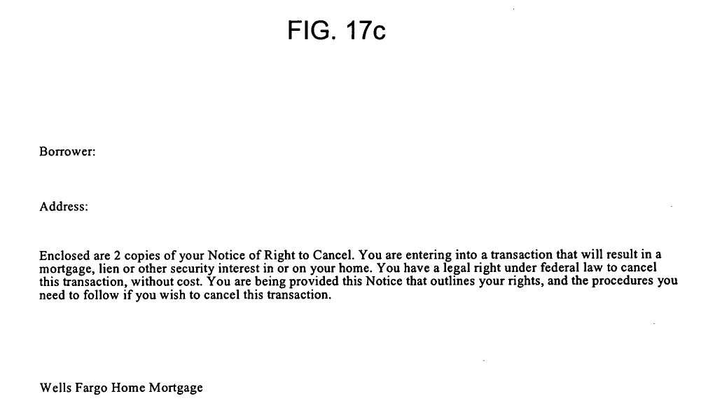

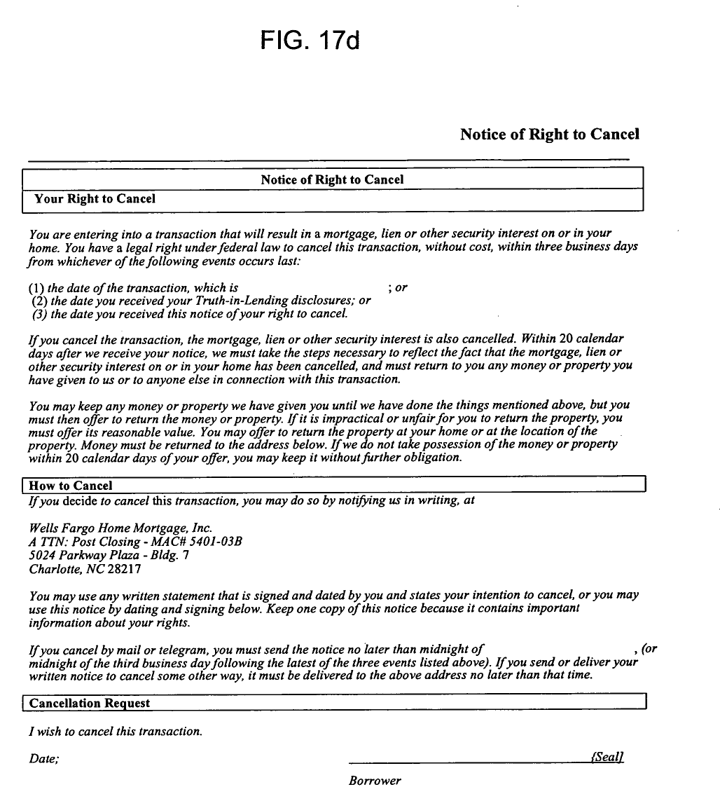

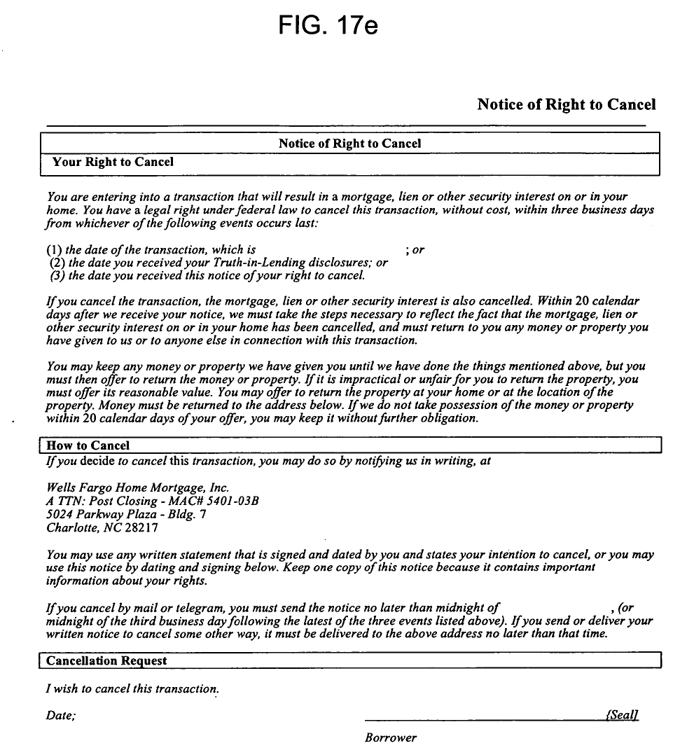

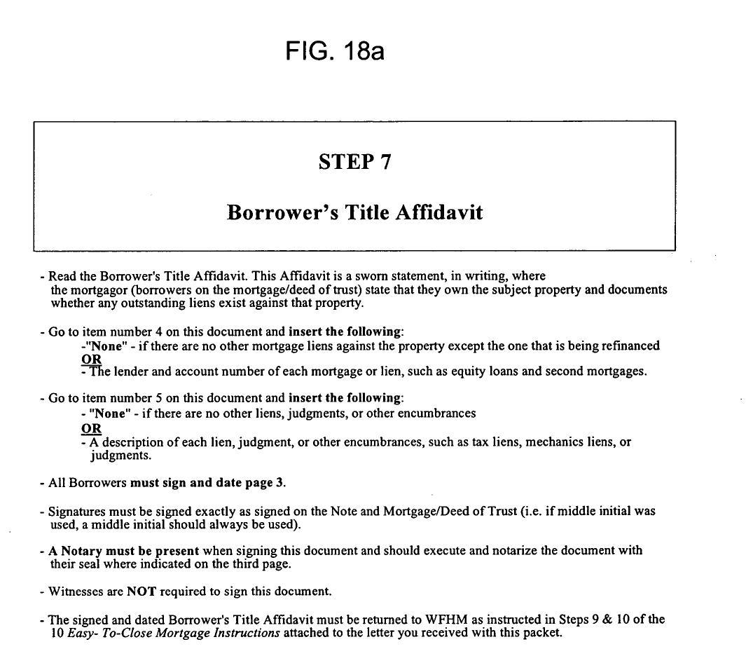

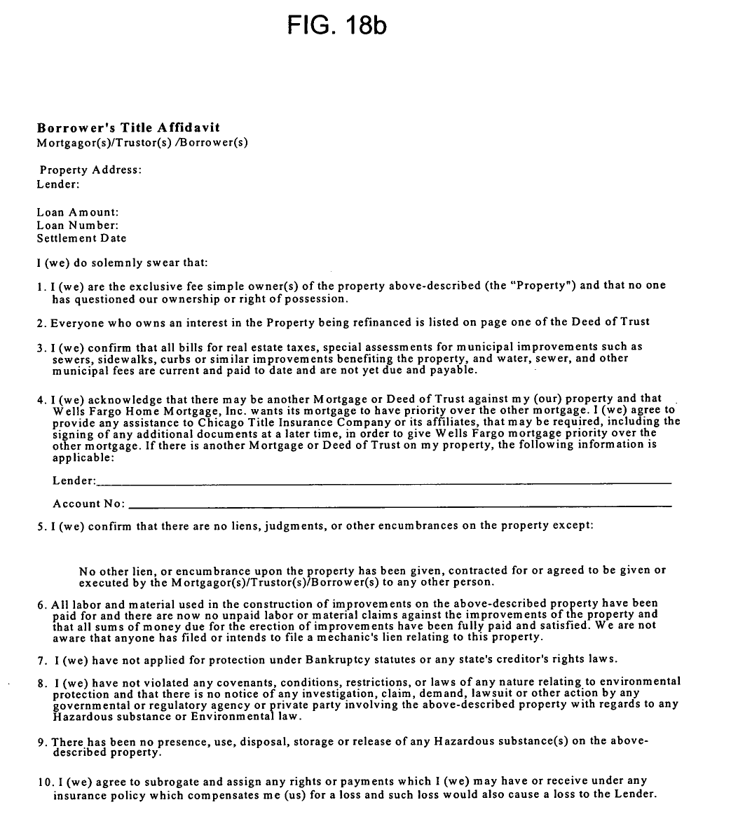

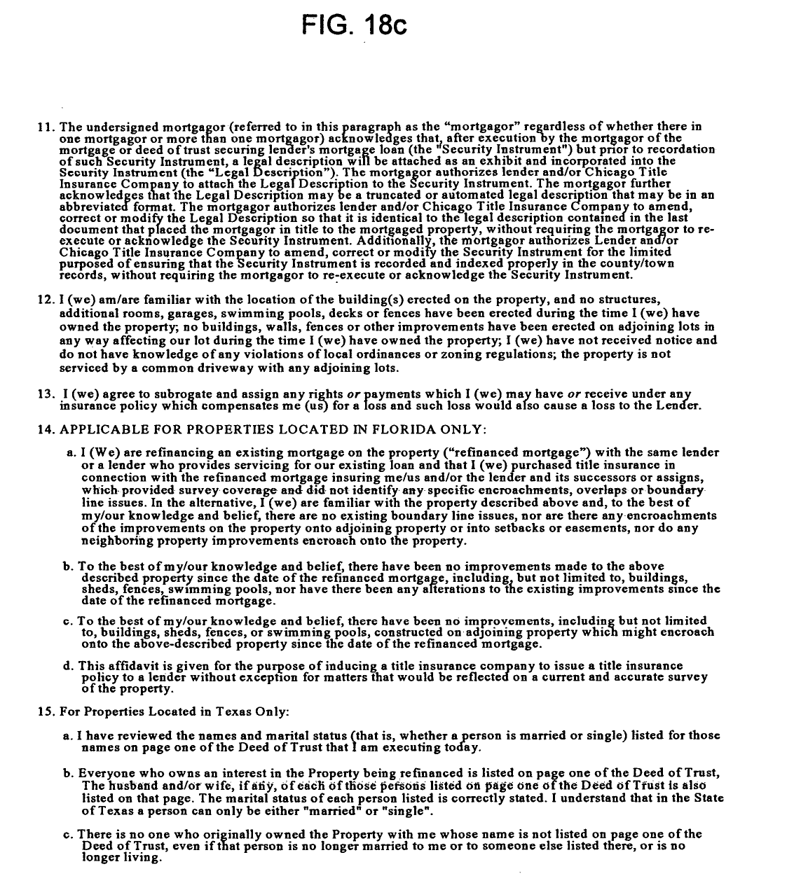

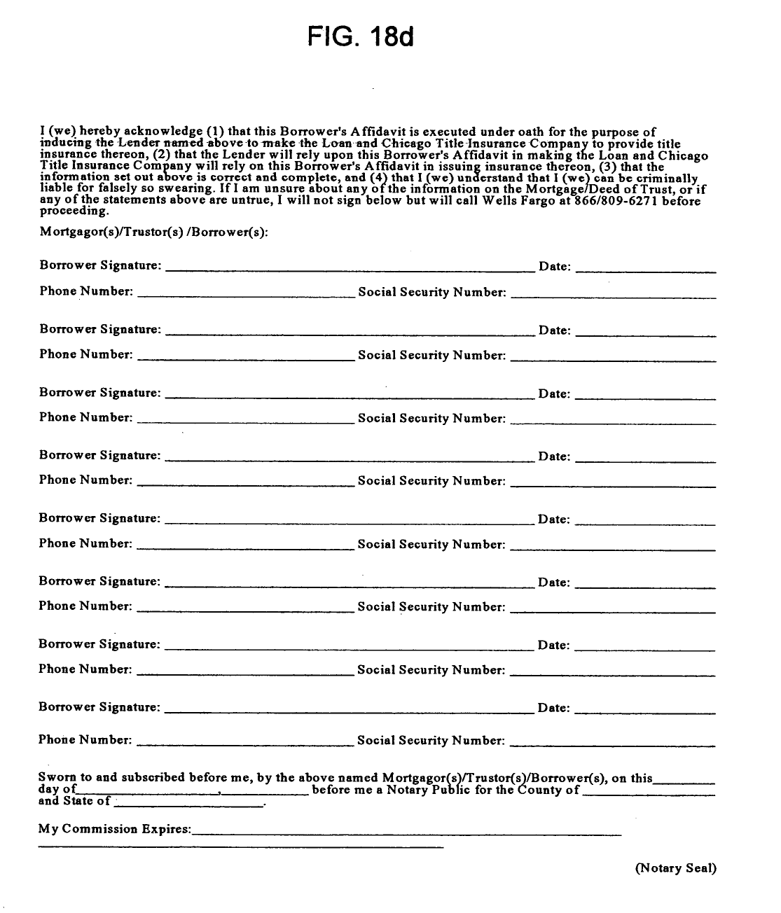

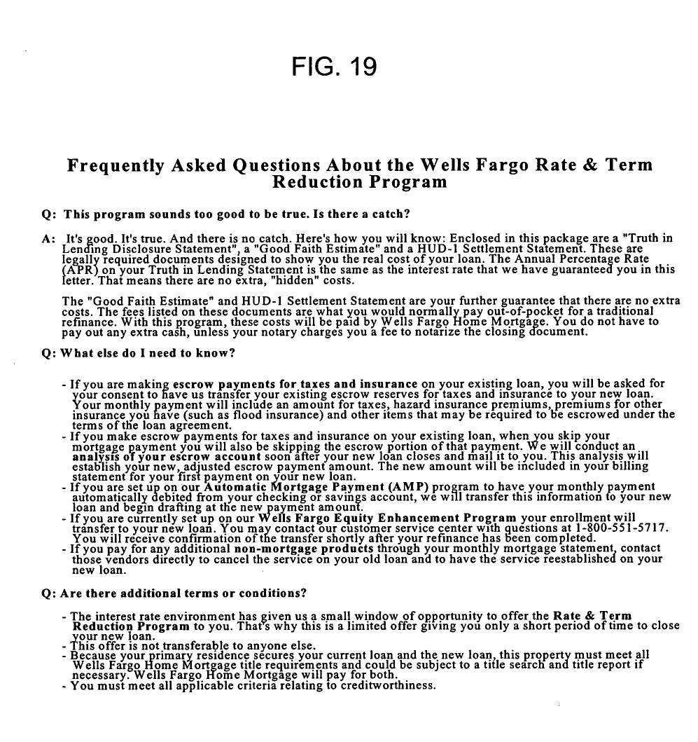

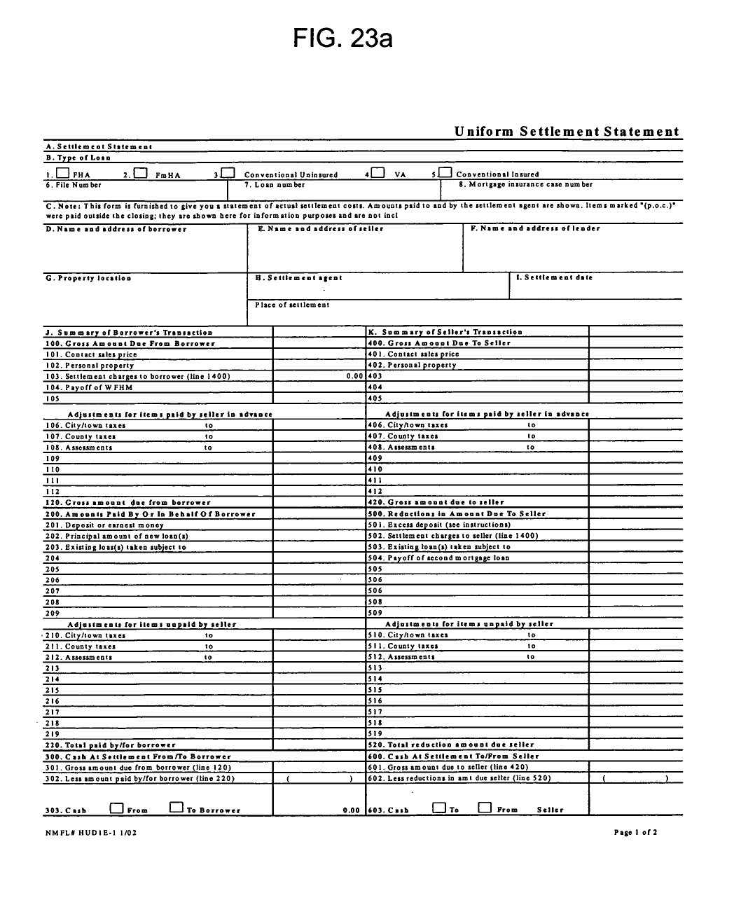

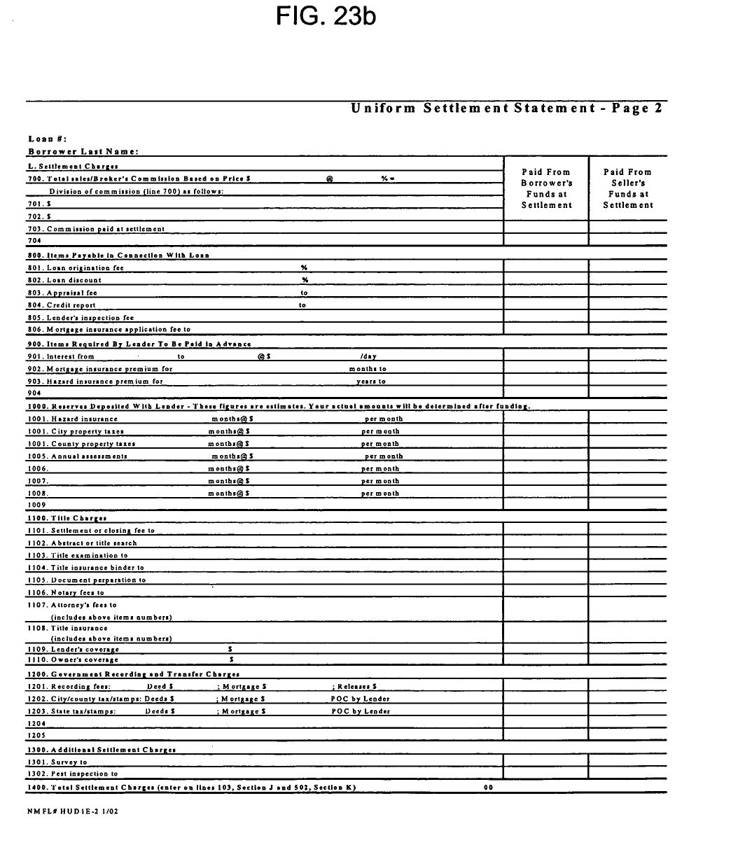

FIGS. 11 through 24 show the various documents that are incorporated into the text of the closing package 100. The closing package of the preferred embodiment, in particular, the set of closing package documents 102 and accompanying text 114, provides a set of instructions for the customer's assistance in completing and executing the closing package documents 110 without the aid of a lender representative. The instructions provide a detailed description of the process and procedures necessary to complete the closing package 100 and to fill out and execute the closing documents 110 contained in the closing package 100. A checklist (FIG. 12) accompanies these instructions to ensure that the customer has performed each step that is required to complete the closing package 100. Instructions to a notary (FIG. 13) are further provided in the closing package 100 of the preferred embodiment. Likewise, a list of frequently asked questions (FIG. 19) is provided to preempt any concerns the customer may have. Furthermore, a note (FIGS. 14a through 14d), a mortgage or deed of trust (FIGS. 15a through 15p), and, in some situations, a rider are provided in the closing package 100. An acknowledgement of the receipt and notice of the right to cancel (FIGS. 17a through 17e) and the borrower's title affidavit (FIGS. 18a through 18d), in which the customer swears that the customer has proper title to the property of interest, are also included in the closing package 100. In addition, a document 110 is included in the closing package 100 that contains a variety of business acknowledgements, agreements, and disclosures covering multiple state and federal disclosure requirements (FIGS. 16a through 16f). Essentially, this document 110 provides a description of the customer's rights and requirements during a mortgage transaction. The customer's signature on this document 110 acknowledges that the customer has received the state and federally required disclosures. A Uniform Settlement Statement (FIGS. 23a & 23b) may also be incorporated into the closing package of the present invention. In the preferred embodiment of the present invention, the closing package 100 sent to the customer contains two sets of documents 102 or workbooks 100. One set of documents is for the customer to retain for the customer's records. The other set of documents is to be returned to the lender. These workbooks may have duplicate copies of the documents 102, 110, or may contain a document 110 that is not contained in the other workbook 100. The specific documents 110 that are included in each closing package workbook 100 is dependent upon the lender's purposes with respect to the particular campaign and the relevant legal requirements. In addition to the two sets of documents, a return-addressed envelope is provided, so the customer may return one set of documents to the lender.

It is contemplated that an electronic form of the closing package 100 may be used. It is also contemplated that other documents, materials, or disclosures, or additional documents, materials, or disclosures may be included in the closing package 100 without departing from the overall scope of the invention.

In one embodiment, closing packages 100 are tailored to meet particular laws, requirements, and disclosures of different geographic states, as well as federal requirements. It is understood that most states have specific closing requirements. These different closing requirements will not change the overall result of the method of refinancing a mortgage loan of the present invention. Examples of such variations in state closing practices include, but are not limited to, requiring the physical presence of an attorney at the closing, requiring attorney review of the closing documents, and a mortgage tax. In the preferred embodiment, due to the different closing requirements that exist, closing packages 100 are prepared with the relevant documents and disclosures for the particular state involved in the refinancing process. Also included in the closing package 100 to accommodate the variations in state laws, is the document containing multiple acknowledgements, agreements, and disclosures to cover a wide variety of state laws and requirements, as well as federal requirements (FIGS. 16a through 16f). An automated process such as a programmable computer that implements a software program accesses and reviews databases or stores of information containing state and federal requirements, and uses this information to assemble a closing package 100 with the necessary documents and disclosures to tailor the closing package 100 to meet the laws and requirements of that particular state. It is contemplated that other means of assembling the closing package 100 could be used, such as manual assembly of the closing packages, without departing from the overall scope of the invention.

The closing packages 100 of the preferred embodiment, therefore, provide a closing that is presented in a form that is easy for the customer to complete and may be completed in a short period of time. The closing packages 100 also provide for accelerated processing by the lender. Furthermore, as the closing packages 100 are sent to the customers and can be returned to the lender in the same manner, no meetings are required. As a result, the closing process is significantly reduced in time, effort, and expense for both the customers and the lender.

Typically, closing costs associated with refinancing a mortgage loan include multiple costs and fees, such as interest rate charges, origination fees, mortgage insurance, title insurance, escrow reserves, hazard insurance, discount points, and miscellaneous other charges. The preferred embodiment of the present invention, however, contains no closing costs paid by the customer.

FIG. 3 shows the preparation of the closing packages by the lender. Loan information from the loan information system is used to generate closing packages to be printed and sent to customers. It is contemplated that the closing package may also be assembled manually. The closing packages are reviewed for errors. As non-limiting examples, an error may be discovered in the legal vesting language, or an error may be an incorrect address on an envelope. If no error is detected, the closing package is printed and sent to a customer who has accepted the offer to refinance. In the preferred embodiment, the documents are printed and sent in a batch by a third party. Alternatively, if an error is detected, the error is corrected and the closing package is sent directly to the customer from the lender following the correction. The closing package, in the preferred embodiment, is provided to the customer by means of overnight delivery to the customer. Alternatively, it is contemplated that any form of delivery is acceptable for purposes of the present invention, including but not limited to, regular mail, courier, electronic means, such as email or Internet processes, or hand delivery.

Following the delivery of the closing package to the customer, the customer completes and executes the appropriate documents contained therein, including any necessary notarization. The customer then returns the lender's copy of the closing package to the lender. The closing package may be returned to the lender in any manner that provides the lender with the executed closing package documents, including, but not limited to, regular mail, courier, electronic means, such as email or Internet processes, or hand delivery. In the preferred embodiment of the present invention, the customer is provided a return addressed overnight envelope in the closing package. Regardless of whether the envelope is included, the customer preferably returns the executed closing documents by overnight delivery. The customer is typically provided a limited amount of time in which to complete and return the closing package documents. When a customer does not return the closing package documents, the lender may contact the customer. It is contemplated, however, that an unlimited time may be given to the customer to complete and return the closing package without departing from the scope of the invention.

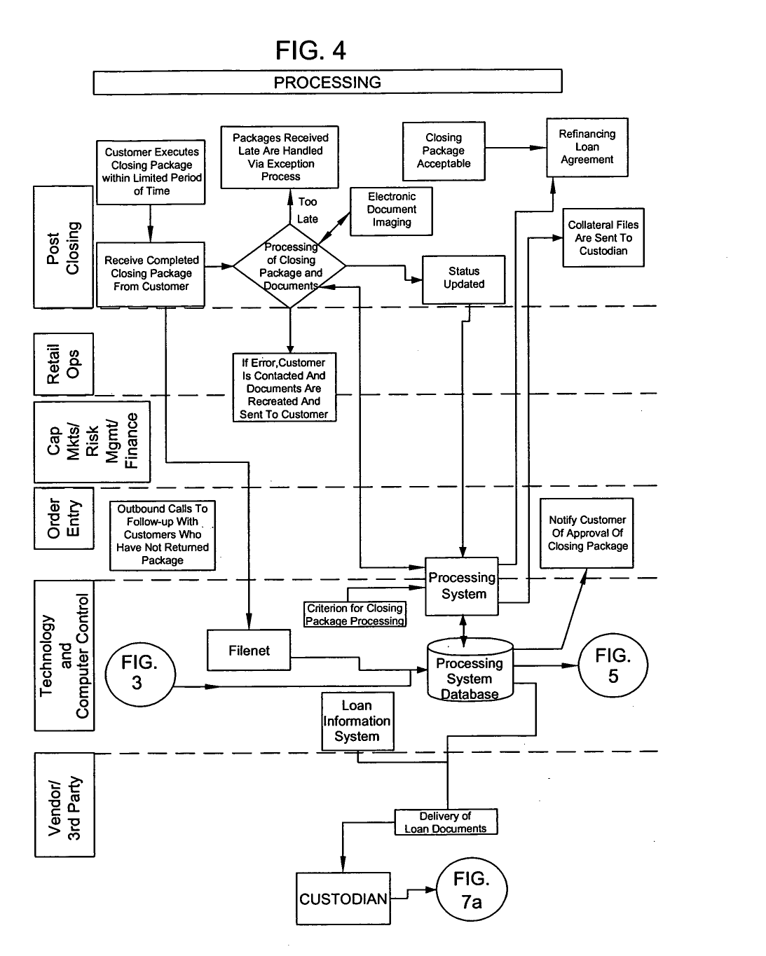

Before processing of the closing package documents that are returned from the customer, but after confirmation of the customer's acceptance of an offer to refinance a mortgage loan, the information from the order entry system is transferred to a processing system (FIG. 4). This processing system is used for receipt and processing, or auditing, of the completed closing package workbooks and closing documents returned by the customers. During a traditional method of refinancing a mortgage loan, the closing documents are received by the lender for processing at the completion of the closing. In the present invention, completed closing documents are received for processing before the closing process is considered completed. Therefore, the processing system of the preferred embodiment is also provided, in part, to track the completed closing packages and documents in the lender's systems.

When the closing packages are completed by the customers and returned to the lender, the closing packages are evaluated by the lender. In the preferred embodiment, the lender uses the processing system to evaluate these packages (FIG. 4). The processing system of the preferred embodiment is an automated program, such as an electronic processing system controlled by a software program connected to a programmable computer. However, it is contemplated that alternative processing systems are capable of being used with the present invention, such as, but not limited to, an individual representative receiving and processing the closing packages, or a computer software program for use in assisting the receipt and processing of the closing packages. It is also contemplated that an Internet process may be used to receive and process closing packages. The processing system of the preferred embodiment involves the scanning and recordal of the processing notation attached to the closing package workbooks and closing documents to note in the processing system receipt of the closing packages and documents. The processing system, therefore, allows the lender to track these closing packages and closing documents throughout the lender's systems. Once the lender notes that the completed closing package has been received, the customer's status is updated to order received status in the processing system, indicating that the closing documents have been received. The closing package is then reviewed for errors.

To evaluate the closing packages for errors, the processing system compares at least one criterion to the closing package workbook and closing documents received from the customer, but may alternatively compare multiple criteria. In the preferred embodiment, multiple criteria are compared to the closing package workbook to evaluate the completeness and correctness of the documents contained therein. As will be discussed in more detail herein, these criteria generally include, but are not limited to, the correct number of documents, the appropriate documents, and the correct signatures. If an error is detected, the customer is contacted and the documents are recreated and sent to the customer for completion.

Processing of the closing documents of the present invention is assisted by electronic document imaging. Particularly, handheld scanners are used to extract data from the returned completed closing package. The closing package is then imaged and made available for later retrieval or reference. The electronic document imaging may detect an error in a document, such as a document that is not completed correctly, in which case, the document imager notes the error and alerts the lender. Subsequently, a manual review of the document is performed to determine the error and the steps that must be taken to correct the error. Often times, when an error is detected, the document, or a new document, is sent to the customer for correction. Alternatively, processing may occur by a manual review of the documents. Contrary to current processes, in the preferred embodiment, document imaging occurs prior to the steps of payoff and funding of the mortgage loan.

The processing system of the preferred embodiment comprises loan verification, image verification, exception verification, and document verification. Loan verification involves reviewing the loan to ensure that the correct terms were provided. Image verification includes verifying whether the correct documents were correctly scanned into a computer. Exception verification involves noting exceptions or problems with the loan information, the images, or the documents. Document verification involves noting the documents that were received with the closing package, including but not limited to, the various disclosures, an escrow option form, the mortgagor's title affidavit, the note, the rider, the right of rescission, and the unrecorded mortgage or deed of trust.

For each document and closing package, a list of criteria is compared to each respective document and closing package to validate the documents and closing packages. These criteria include, for example: whether the note is missing; whether the property address, loan amount, interest rate, or maturity date are blank; whether the contents or dates have been altered or changed in any way, or whether there is white out on the form; whether signatures are missing; whether any pages are missing; whether the printed signatures match the signature line; whether the rider box was checked; whether the legal description is missing; whether a notary has notarized correctly; whether any liens were listed; and whether an escrow option was chosen. It is understood that any criterion may be applied to any document that ensures that the document is acceptable for the lender's purposes. These criteria, in one embodiment, are combined with digital images of the documents so that a lender representative can evaluate the documents and complete the processing of the closing package.

At the completion of processing of the closing package, any additional loan information generated during this process is sent to the loan information system. The loan documents are sent to a custodian. Particularly, in the preferred embodiment, the closing documents are delivered to the custodian prior to payoff of the existing mortgage loan and funding of the new mortgage loan.

The normal post-closing workflow processing of a refinanced mortgage loan associated with current processes of obtaining refinancing is also suppressed in the preferred embodiment because the mortgage loan has not been generated in the typical or traditional fashion, although it is contemplated that the traditional workflow processing may be used.

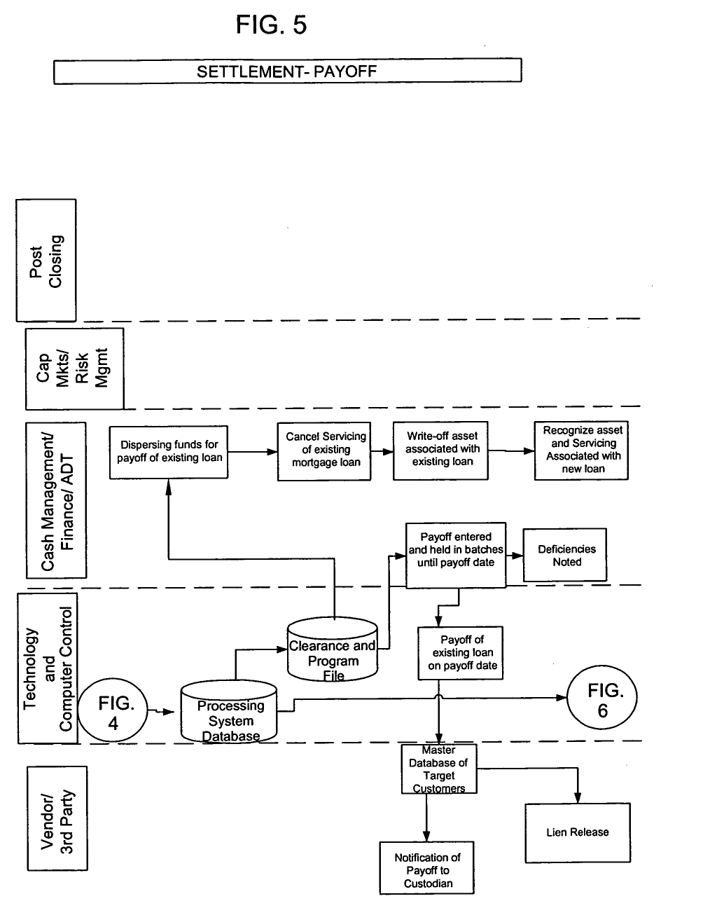

As shown in FIGS. 5 & 6, after approval of the documents, the processing system assists the settlement and payoff of the existing mortgage loan. The processing system also assists the funding of a new mortgage loan and provides information regarding the new mortgage loan to the loan information system. Particularly, after the processing and approval of the closing package, clearance and funding files are prepared. Clearance files are files that contain all the information and documents necessary for settlement and payoff of the existing mortgage loans. Funding files are files that contain all of the information and documents necessary for funding of a new mortgage loan.

During settlement, the clearance program notifies the lender that funds must be dispersed to pay off the existing mortgage loan held by the customer. Loan information from the clearance file is used to manage the disbursement of funds for purposes of paying off an existing mortgage loan. The payoff amount is held in the clearance file until disbursement. In the preferred embodiment, the payoff amounts for more than one customer are held in a batch until a payoff date. The payoff date is the date on which the lender transfers funds or records the payoff of an existing mortgage loan in its records.

Payoff amounts are compared to the amount that is owed for each loan. Shortages or differences between the payoff amount and the actual amount due on the existing mortgage loan are noted, and appropriate steps are then taken, such as collection or refund, to correct the noted deficiencies. Subsequently, the existing mortgage loan is paid off on the payoff date.

Once the loan is paid off, the payoff is noted in the master database and a custodian is notified of this payoff. Furthermore, the necessary steps are taken to release the lien on the property held as collateral for the existing mortgage loan in a county recording system. At the same time, mortgage documents for the new mortgage loan are sent for recordation. The clearance program, after disbursement of funds by the lender, cancels the lender's servicing of the existing mortgage loan. The clearance program also recognizes the new mortgage loan in the lender's system for servicing. Information from the clearance file is then sent to the master database.

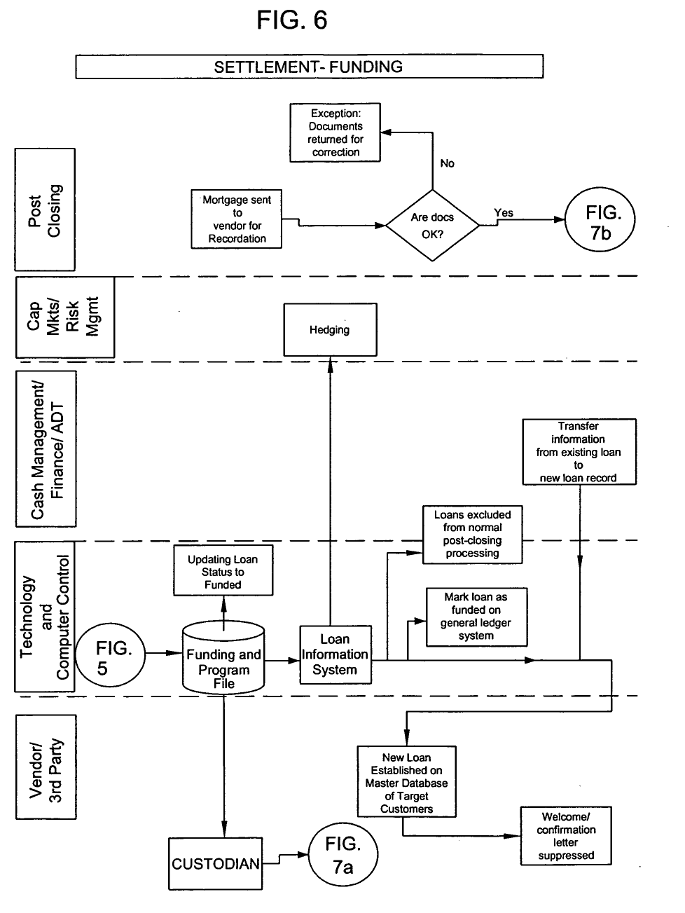

As shown in FIG. 6, at the time of the payoff of the existing mortgage loan, the funding program ensures that the lender provides the necessary financial support to the new mortgage loan. Specifically, loan information is first transferred from the processing system to a funded file. Typically, payoff and funding involve the exchange of money between two or more lenders. For offers to refinance in the preferred embodiment, loans are offered to the lender's own customers from previous transactions. Therefore, no money needs to be transferred from an existing loan to a new loan. Instead, the lender notes on its financial records that a customer's existing mortgage loan is paid off and a new mortgage loan is funded. Alternatively, when a lender provides refinancing to a customer who was not previously a customer of the lender, then the transfer of money between parties would be necessary.

After the funding of the new loan, the status of the customer's loan is updated to funded status. In the preferred embodiment, the status of several loans are updated to funded status in a batch. The information in the funded file is transferred into the loan information system. The loan information system provides this information to the lender to use in hedging against the risks of interest rate fluctuation associated with these new mortgage loans. The loan information system also provides loan information to the post-closing workflow system for post-closing processing. Information from the loan information system is also posted on the lender's general ledger system to indicate that the loan has been funded. A new loan is established in the lender's master database, and the loan information from the loan information system is combined with information that has been transferred in the master database from the customer's old loan to the customer's new loan.

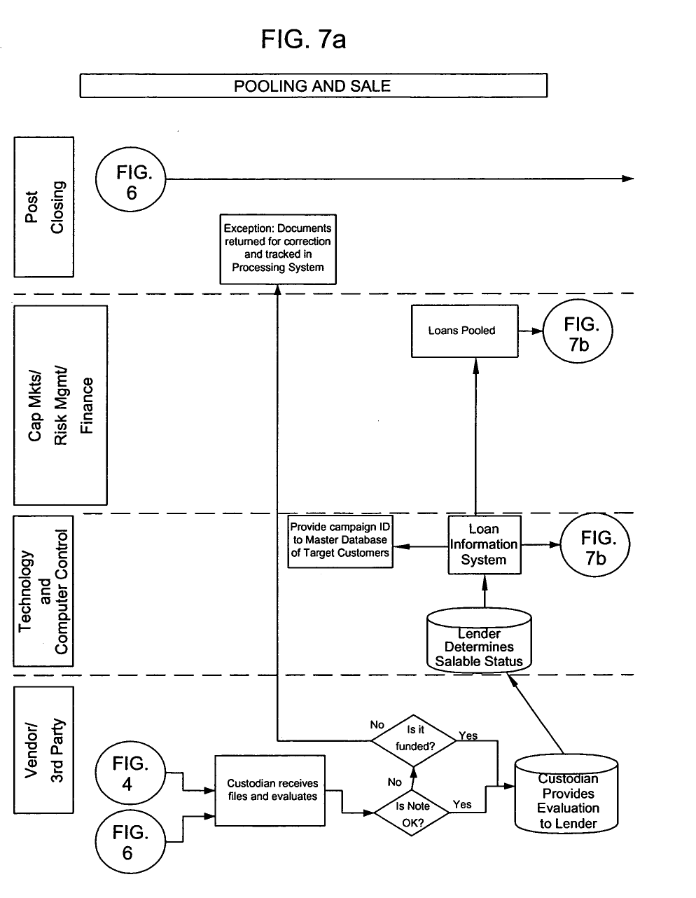

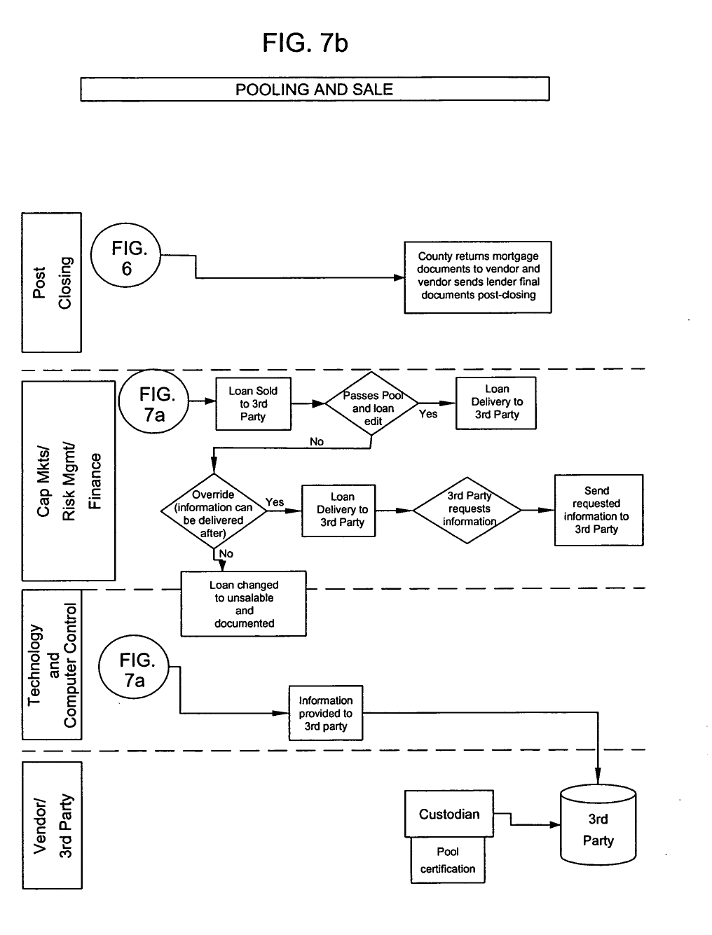

The custodian, as shown in FIG. 7a, has been provided loan information from the processing and loan information systems for each customer in a batch. In the post-closing workflow processing of the present invention, during clearance, the documents from the new loan are also provided to the custodian. The custodian evaluates the documents and mortgage notes it receives for completeness and to ensure that each mortgage loan is funded. The custodian compares the mortgage note for each customer against the data collected for each customer from the loan information and processing systems to ensure the information and documentation is correct. If the note is acceptable, the custodian notifies the lender. In the preferred embodiment, the lender then determines the saleable status of the new mortgage loan and provides this status to the loan information system. The lender then has the option to make the note available for sale. Alternatively, when a problem is discovered in the documents or the note, the lender is alerted by the custodian of the problem and the documents are returned for correction.

Subsequently, the lender assigns an identification in the master database for the individual campaign that generated these new mortgage loans. Next, the lender selects the saleable mortgage loans of the individual customers that are to be pooled together and offered for sale on the secondary mortgage market. In the preferred embodiment, the lender provides these pooled loans to a third party purchaser. However, it is contemplated that the lender may retain some of these mortgage loans in its portfolio. Similarly, the lender may sell the servicing associated with selected new loans, or the lender may retain these loans for servicing itself.

As shown in FIG. 7b, in the preferred embodiment, the process of supplying the loans to a third party purchaser involves selecting loans from the loan information system to be pooled together for sale. An edit is performed on the pool of loans prior to providing the loans to the third party. Loan information is then downloaded or transferred from the loan information system to the third party. The loans that are determined to be acceptable by the lender, following the edit, are delivered to the third party purchaser. At the same time, the custodian transfers a certification for the pool of mortgage loans to the third party. Alternatively, the loans that are deemed not acceptable are either delivered to the third party with missing information that will be delivered at a later date, or the loan is changed to an unsaleable status and the lender is alerted that a correction needs to be made. Any information not previously provided to the third party purchaser may be transferred from the loan information system to the third party at a later date.

The method of refinancing a mortgage loan of the present invention is adaptable to fit a wide variety of mortgage lending services. The embodiments shown are especially well suited for refinancing a mortgage loan. However, the invention is in no way so limited. For instance, it would be obvious to modify the invention to provide a method of forming second mortgages, as opposed to refinancing. Furthermore, it is anticipated that certain geographic states will have certain requirements and lending restrictions for obtaining a mortgage loan, but these differing requirements will not change the overall result of the method of refinancing a mortgage loan.

The foregoing description and drawings merely explain and illustrate preferred embodiments of the invention, and the invention is not limited thereto, except insofar as the claims are so limited. Those skilled in the art, who have the disclosure before them, will be able to make modifications and variations therein without departing from the scope of the invention. For example, while applying filters to a master customer database to create a target list of customers to be offered a mortgage loan is provided, it is contemplated that no filtering may occur prior to preparing or sending an offer to a group of customers. In addition, modifications may be necessitated due to certain state specific requirements and lending restrictions as previously discussed hereinabove. For example, a particular state may require that an attorney must physically attend a closing. Likewise, another particular state may not have a provision for title insurance.

What is claimed is:

1. A closing package for a mortgage loan comprising:
closing documents to be executed by a customer;
at least one document comprising instructions providing guidance to said customer for completing and executing said closing documents in the absence of a meeting, said instructions comprising a checklist of steps for said customer's guidance and steps for a notary's guidance in said completion and execution of said closing documents; and
at least one document comprising a plurality of acknowledgements, agreements, and disclosures accommodating variations in legal requirements relating to said closing documents.

2. A method of refinancing a mortgage loan comprising:
pre-approving a customer for refinancing of a mortgage loan;
sending an offer for said refinancing to said customer, said offer comprising materials setting forth terms of said refinanced mortgage loan, materials providing pre-acceptance disclosures and conditions, and instructions describing how said customer may accept said offer;
at least one of said terms of said refinanced mortgage loan comprising a specific, locked interest rate;
receiving an indication of acceptance of said offer from said customer; and
sending a closing package to said customer to be executed by said customer, said closing package comprising closing documents to be executed by said customer, at least one document comprising instructions providing guidance to said customer for completing and executing said closing documents in the absence of a meeting, said instructions comprising a checklist of steps for said customer's guidance and steps for a notary's guidance in said completion and execution of said closing documents, and at least one document comprising a plurality of acknowledgements, agreements, and disclosures accommodating variations in legal requirements relating to said closing documents, said execution of said closing documents by said customer creating a refinancing loan agreement.

3. A method of refinancing a mortgage loan comprising:
pre-approving a customer for refinancing of a mortgage loan;
sending an offer for said refinancing to said customer, said offer comprising materials setting forth terms of said refinanced mortgage loan, materials providing pre-acceptance disclosures and conditions, and instructions describing how said customer may accept said offer;
at least one of said terms of said refinanced mortgage loan comprising a specific, locked interest rate;
receiving an indication of acceptance of said offer from said customer; and
sending a closing package to said customer to be executed by said customer, said closing package comprising closing documents to be executed by said customer, at least one document comprising instructions providing guidance to said customer for completing and executing said closing documents in the absence of a meeting, said execution of said closing documents by said customer creating a refinancing loan agreement.

4. A method of refinancing a mortgage loan comprising:
pre-approving a customer for refinancing of a mortgage loan;
sending an offer for said refinancing to said customer, said offer comprising materials setting forth terms of said refinanced mortgage loan, materials providing pre-acceptance disclosures, and instructions describing how said customer may accept said offer;
at least one of said terms of said refinanced mortgage loan comprising an interest rate and a term length;
receiving an indication of acceptance of said offer from said customer; and
sending a closing package to said customer to be executed by said customer, said closing package comprising closing documents to be executed by said customer, at least one document comprising instructions providing guidance to said customer for completing and executing said closing documents in the absence of a meeting, said execution of said closing documents by said customer creating a refinancing loan agreement.

5. A method of refinancing a mortgage loan comprising:
receiving a request to refinance a mortgage loan from a customer;
communicating an offer for said refinancing to said customer, said offer comprising materials setting forth terms of said refinanced mortgage loan, materials providing pre-acceptance disclosures, and instructions describing how said customer may accept said offer;
at least one of said terms of said refinanced mortgage loan comprising a specific interest rate and a specific term length;
receiving an indication of acceptance of said offer from said customer; and
sending a closing package to said customer to be executed by said customer, said closing package comprising closing documents to be executed by said customer, at least one document comprising instructions providing guidance to said customer for completing and executing said closing documents in the absence of a meeting, said instructions comprising a checklist of steps for said customer's guidance and steps for a notary's guidance in said completion and execution of said closing documents, and at least one document comprising a plurality of acknowledgements, agreements, and disclosures accommodating variations in legal requirements relating to said closing documents, said execution of said closing documents by said customer creating a refinancing loan agreement.
